(19) United States
(12) Patent Application Publication
(10) Pub. No.: US 2023/0144844 A1
(43) Pub. Date: May 11, 2023

(54) SYSTEMS AND METHODS FOR MANAGING A PERSONALIZED ONLINE EXPERIENCE

(71) Applicant: AUTOMAT TECHNOLOGIES, INC., Montreal (CA)

(72) Inventors: Ali Erdem OZCAN, Montreal (CA); Arman C KIZILKALE, Montreal (CA); Priya SIDHAYE, Montreal (CA); Matthieu LECLERCQ, Montreal (CA); Andy MAURO, Montreal (CA); Benjamin BRUNEAU, Montreal (CA); Aran RASMUSSEN, Montreal (CA); Gabriella HACHEM, Montreal (CA); Nimrat CHEEMA, Montreal (CA); Justin EVANS, Montreal (CA); Alexandra Nichole DEWIT, Montreal (CA)

(21) Appl. No.: 17/802,592

(22) PCT Filed: Feb. 26, 2021
(86) PCT No.: PCT/IB2021/051625

§ 371 Date: Aug. 26, 2022

Related U.S. Application Data
(60) Provisional application No. 62/982,907, filed on Feb. 28, 2020.

(51) Int. Cl. G06Q 30/0601; G06Q 30/0282

(52) U.S. Cl. CPC G06Q 30/0631; G06Q 30/0282

(57) ABSTRACT

There is disclosed a method and system for engaging in a dialog with a user. The dialog system may receive input from the user. The dialog system may determine text for responding to the user. The dialog system may determine products to recommend to the user. The dialog system may generate a summary of reviews corresponding to the products. A response may be output to the user based on the text for responding to the user, the products to recommend to the user, and the summary of reviews corresponding to the products.

### CROSS-REFERENCE TO RELATED APPLICATIONS

This application claims the benefit of U.S. Provisional Patent Application No. 62/982,907, filed Feb. 28, 2020, which is incorporated by reference herein in its entirety.

### BACKGROUND

Conversational systems, such as chatbots, may be used to assist customers in selecting products to purchase. The conversational systems may be integrated in a web page or application, such as a mobile application, of a seller. The conversational systems may be intended to increase the likelihood that a visitor to a retailer's web site will purchase a product.

Typical conversational systems are manually programmed to provide information about products. To interact with the conversational system, the user may be provided a survey or options that may be selected. The process of creating a conversational system may be time consuming and/or costly. Each time a product is added or removed by the seller, the conversational system may be manually updated. It may be preferable to reduce the amount of time and/or resources used to create and/or maintain a conversational system. It may be preferable to create a conversational system that leads to increased user engagement with the conversational system and/or increased sales resulting from use of the conversational system.

### SUMMARY

A customer's online experience may be personalized using a conversational system, by selecting a variant of a web page or of an element on a web page, by providing recommendations for the customer, by providing product reviews to the customer, and/or by providing other personalized experiences for the customer. A user may engage in a conversation with a dialog system through a variety of interfaces. The user may visit a web page, such as a retailer's web page, that integrates the user interface of the dialog system in the web page. The user may interact with the dialog system using a chat system, such as a third-party chat client that the user already uses. The user may interact with the dialog system using an application, such as a retailer's application executing on the user's mobile device. A single retailer may implement one or more of these interfaces to engage customers in a conversation with the dialog system. The user may interact with the dialog system by answering a survey, selecting one or more options, entering text input, speaking audio input, and/or by providing any other type of input.

The conversation between the user and the dialog system may include multiple dialog turns. At each dialog turn, the user may enter input or the dialog system may output a response. During a dialog turn the user may ask a question or respond to a question output by the dialog system. The user may select a product during a dialog turn. Other input may be entered by the user during the dialog turn. The conversation may be directed to determining a product or products that would fit the user's needs and/or preferences. The conversation may relate to all available products, such as all products offered at a retailer's online store. The conversation may be focused on a given product and/or category of products. For example if a user is considering purchasing a specific product, the conversation may be directed to determining whether the product will meet the user's expectations.

After receiving input from a user during a dialog turn, the dialog system may generate a response and output the response to the user. The response may include text, such as a response to a question that the user entered during the prior dialog turn. The response may include images, such as images of products. The response may include selectable elements for selecting pre-filled responses, such as a carousels or buttons. The dialog system may output questions to the user, to gain further information about the user and their needs. The user may type a response, select a response, speak audio in response to the question, and/or input a response to the question using any other method.

The dialog system may output recommended products. The recommended products may be determined based on the input entered by the user and/or stored information corresponding to the user. The dialog system may output reviews corresponding to the recommended products. The recommended products may fit the user's needs and/or preferences. The recommended products may be bundles of products that may be used together. The dialog system may output whether a specific product is suitable for the user, and, if the product is not suitable for the user, the dialog system may output other suitable products that are determined to meet the user's needs and/or preferences.

The responses determined by the dialog system may be intended to increase the likelihood that a user is recommended products that best fit their needs and/or that they are more likely to purchase.

According to a first broad aspect of the present technology, there is provided a method for determining a response to a user input received during a conversation with a dialog system, the method comprising: receiving the user input from the user; retrieving a conversation state corresponding to the conversation, wherein the conversation state comprises a user profile and a record of the conversation; updating the conversation state based on the user input; determining, based on the conversation state, one or more possible next dialog turns; selecting, from the one or more possible next dialog turns, a next dialog turn for the conversation; determining, based on the conversation state, one or more products to be recommended to the user, wherein each of the one or more products to be recommended is indicated as available to be recommended; generating, based on the next dialog turn and the one or more products, the response; and outputting the response to the user.

In some implementations of the method, determining the one or more products comprises: retrieving, from a product database, a plurality of products, wherein each product has been labelled with labels from a label ontology, and wherein the user profile comprises one or more labels from the label ontology; ranking, based on an amount of labels that each product has in common with the user profile, the plurality of products, wherein higher-ranked products have a higher amount of labels in common with the user profile; and selecting the one or more products by selecting a pre-determined amount of highest-ranked products.

In some implementations of the method, the method further comprises: determining that a product in the product database is not available; and storing, in the product database, an indication that the product is not available to be recommended.

In some implementations of the method, the method further comprises determining whether each of the one or more products to be recommended to the user is currently available.

In some implementations of the method, determining whether each of the one or more products to be recommended to the user is currently available comprises determining whether each of the one or more products to be recommended to the user is in-stock.

In some implementations of the method, the method further comprises outputting a web page comprising the one or more products, wherein the web page comprises an indication for each of the one or more products indicating that each of the one or more products is a recommended product.

In some implementations of the method, selecting the next dialog turn comprises filtering the one or more possible next dialog turns to remove dialog turns corresponding to unavailable products.

In some implementations of the method, selecting the next dialog turn comprises: ranking, based on a conversation template, the one or more possible next dialog turns; and selecting a highest-ranked dialog turn of the one or more possible next dialog turns as the next dialog turn.

According to another broad aspect of the present technology, there is provided a method for determining a response to a user input received during a conversation with a dialog system, the method comprising: receiving the user input from the user; retrieving a conversation state corresponding to the conversation, wherein the conversation state comprises a user profile and a record of the conversation; determining one or more entities corresponding to the user input; determining one or more intents corresponding to the user input; updating the conversation state based on the one or more entities and the one or more intents; determining, based on the conversation state, one or more possible next dialog turns; selecting, from the one or more possible next dialog turns, a next dialog turn for the conversation; determining, based on the conversation state, one or more products to be recommended to the user, wherein each of the one or more products to be recommended is indicated as available to be recommended; determining, based on the one or more products, a summary of reviews corresponding to the one or more products; generating, based on the next dialog turn, the one or more products, and the summary of reviews, the response; and outputting the response to the user.

In some implementations of the method, the user input comprises text.

In some implementations of the method, the user input comprises a selection of a selectable element.

In some implementations of the method, the selectable element is an element displayed in a carousel.

In some implementations of the method, the selectable element is a button.

In some implementations of the method, the one or more products to be recommended to the user comprises products in a bundle.

According to another broad aspect of the present technology, there is provided a method for outputting product recommendations, the method comprising: outputting a web page for display, wherein the web page comprises images of a plurality of products and a dialog user interface; outputting, via the dialog user interface, text corresponding to a dialog turn; receiving, via the dialog user interface, user input responsive to the dialog turn; determining, based on the user input, one or more products to recommend; and displaying, on the web page, indicators corresponding to the one or more products to recommend overlaid on the images of the plurality of products.

In some implementations of the method, the dialog user interface comprises a banner in the web page.

In some implementations of the method, a portion of the dialog user interface is initially displayed on the web page.

In some implementations of the method, after a user scrolls the web page, an entirety of the dialog user interface is displayed on the web page.

In some implementations of the method, the method further comprises displaying, on the web page, a portion of a review corresponding to a product of the one or more products to recommend.

According to another broad aspect of the present technology, there is provided a method for determining a response to a user input received during a conversation with a dialog system, the method comprising: receiving the user input; retrieving a conversation state corresponding to the conversation; determining, based on the conversation state, a next dialog turn for the conversation; and outputting, based on the next dialog turn, a response to the user.

In some implementations of the method, the user input is received via an input on a web page displayed to the user, and further comprising: updating, based on the user input, the conversation state; and updating, based on the conversation state, the web page.

In some implementations of the method, the method further comprises: determining a set of available products offered by a retailer; and determining, based on the conversation state, one or more products of the set of available products to be recommended to the user, wherein the response comprises the one or more products.

In some implementations of the method, the method further comprises: determining a set of available products offered by a retailer; retrieving labels corresponding to each product of the set of available products; retrieving labels of a user engaged in the conversation; and selecting, based on comparing the labels of the user to the labels of the products, one or more products of the set of available products to be recommended to the user, wherein the response comprises the one or more products.

In some implementations of the method, the method further comprises: determining one or more entities corresponding to the user input; determining one or more intents corresponding to the user input; and updating the conversation state based on the one or more entities and the one or more intents.

In some implementations of the method, the user input comprises text input by the user.

In some implementations of the method, the user input comprises a selection of one or more selectable elements.

In some implementations of the method, each of the selectable elements corresponds to a label in an ontology of labels.

In some implementations of the method, determining the next dialog turn for the conversation comprises: determining, based on the conversation state, one or more possible next dialog turns; filtering out dialog turns from the one or more possible next dialog turns that are associated with products that are unavailable; and selecting, from the one or more possible next dialog turns, the next dialog turn.

In some implementations of the method, determining the one or more possible next dialog turns comprises determining, based on a conversation template, the one or more possible next dialog turns.

In some implementations of the method, selecting the next dialog turn comprises: ranking, based on the conversation template, the one or more possible next dialog turns; and selecting a highest-ranked dialog turn of the one or more possible next dialog turns as the next dialog turn.

In some implementations of the method, the user input comprises a request to confirm whether a selected product is suitable for a user, and further comprising: determining, based on the conversation state, one or more products to be recommended to the user; determining whether the one or more products includes the selected product; and outputting a response indicating whether the selected product is recommended for the user.

In some implementations of the method, the user input comprises a request to confirm whether a selected product is suitable for a user, and further comprising: determining, based on the conversation state, one or more possible next dialog turns; and selecting, from the one or more possible next dialog turns, a dialog turn relating to the selected product as the next dialog turn.

In some implementations of the method, the user input comprises a request to confirm whether a selected product is suitable for a user, and further comprising: determining, based on the conversation state, one or more possible next dialog turns; filtering out dialog turns from the one or more possible next dialog turns that are not related to the selected product; and selecting a dialog turn of the one or more possible next dialog turns as the next dialog turn.

In some implementations of the method, the method further comprises: transmitting at least a portion of the conversation state to a third party service; receiving data from the third party service; and updating the conversation state based on the data from the third party service.

In some implementations of the method, the response comprises an image, a video, or a sound.

In some implementations of the method, outputting the response comprises outputting the response in a banner chat interface, a conversational landing page interface, a popup web chat interface, or a third-party chat client.

In some implementations of the method, the method further comprises: determining that the user input comprises a query for a product bundle; selecting, based on a user profile, one or more bundle types to recommend; and selecting, based on the user profile, products for each of the one or more bundle types, wherein the response comprises the products.

In some implementations of the method, the method further comprises: determining a set of available products offered by a retailer; retrieving labels corresponding to each product of the set of available products; retrieving labels of a user engaged in the conversation; selecting, based on the labels of the user and the labels of the products, one or more products of the set of available products to be recommended to the user; and generating, based on the labels of the user, text explaining why each of the one or more products is recommended, wherein the response comprises the one or more products and the text.

According to another broad aspect of the present technology, there is provided a method for outputting product recommendations, the method comprising: retrieving a user profile corresponding to a user requesting a web page; determining, based on the user profile, a plurality of products to recommend to the user; outputting the web page, wherein the web page comprises images of the plurality of products; and displaying, on the web page, indicators, overlaid on the images of the plurality of products, indicating that each product of the plurality of products is a recommended product.

In some implementations of the method, the user profile comprises one or more labels associated with the user, and wherein the indicator for a respective product comprises a label, of the one or more labels associated with the user, that corresponds to the respective product.

In some implementations of the method, the user profile comprises a plurality of labels corresponding to the user, wherein the plurality of labels were determined based on input received from the user during a dialog, and wherein determining the plurality of products comprises determining, based on the labels, the plurality of products.

In some implementations of the method, the user profile was generated based on previous interactions with the user.

According to another broad aspect of the present technology, there is provided a method for determining product recommendations for a user, the method comprising: receiving a request for product recommendations corresponding to a user; retrieve a user profile of the user; selecting, from a database of products and based on the user profile, a set of products that are recommendable to the user; and outputting at least one product of the set of products that are recommendable.

In some implementations of the method, selecting the set of products comprises comparing labels assigned to products in the database of products to labels in the user profile.

In some implementations of the method, the method further comprises: determining, for each product of the set of products, a distance between the labels assigned to the respective product and labels in the user profile; and ranking, based on the distance for each product of the set of products, the set of products.

In some implementations of the method, the request comprises a request for a product bundle, and further comprising: retrieving bundle specifications; determining, based on the user profile and the bundle specifications, one or more bundle types that are recommendable to the user; selecting, based on comparing labels in the user profile to product labels, products for each of the one or more bundle types; and outputting the products for each of the one or more bundle types.

In some implementations of the method, the bundle specifications comprise a set of rules indicating which products can be bundled together and which types of products can be bundled together.

In some implementations of the method, the method further comprises: determining that a product in the database of products is unavailable; and storing, in the database of products, an indication that the product is not available to be recommended.

According to another broad aspect of the present technology, there is provided a method for outputting a web page, the method comprising: retrieving a model trained for selecting a variant of the web page from a plurality of variants, wherein the model was trained to select a variant most likely to lead to a predetermined reward; determining, based at least in part on a random selection, whether to select the variant most likely to lead to the reward; selecting the variant most likely to lead to the reward; and outputting the selected variant of the web page.

In some implementations of the method, each of the plurality of variants comprises a variant of an element of the web page.

In some implementations of the method, the element of the web page comprises a banner displayed on the web page.

In some implementations of the method, the method further comprises: storing a record indicating whether the predetermined reward was achieved; and retraining the model based on the record.

According to another broad aspect of the present technology, there is provided a method for outputting a web page, the method comprising: receiving a model trained for selecting a variant of the web page from a plurality of variants, wherein the model was trained to select a variant most likely to lead to a predetermined reward; determining, based at least in part on a random selection, whether to select the variant most likely to lead to the reward; determining, for each variant of the plurality of variants, a predicted likelihood that the respective variant will lead to the predetermined reward; selecting, based on the predicted likelihood for each variant of the plurality of variants and using a biased random selection, a variant of the plurality of variants; and outputting the selected variant of the web page.

In some implementations of the method, the method further comprises: receiving a record indicating whether the predetermined reward was achieved; and retraining the model based on the record.

According to another broad aspect of the present technology, there is provided a method for determining a response to a user input received during a conversation with a dialog system, the method comprising: receiving the user input; retrieving a conversation state corresponding to the conversation; updating, based on the user input, the conversation state; determining, based on the conversation state, one or more products to recommend to a user; retrieving reviews corresponding to the one or more products; ranking, based on a user profile, the reviews; determining, for one or more highest-ranked reviews of the reviews, review summaries; and outputting a response to the user, wherein the response comprises the one or more products and the review summaries.

According to another broad aspect of the present technology, there is provided a method for determining a response to a user input received during a conversation with a dialog system, the method comprising: receiving the user input; retrieving a conversation state corresponding to the conversation; updating, based on the user input, the conversation state; determining, based on the conversation state, one or more products to recommend to a user; retrieving reviews corresponding to the one or more products; ranking, based on a user profile, the reviews; and outputting a response to the user, wherein the response comprises the one or more products and one or more highest-ranked review of the reviews.

In some implementations of the method, the user profile comprises a plurality of labels from an ontology of labels, wherein each of the reviews is associated with one or more labels from the ontology of labels, and wherein ranking the reviews comprises ranking the reviews based on an amount of labels in common between a respective review and the user profile.

According to another broad aspect of the present technology, there is provided a method for outputting product recommendations, the method comprising: receiving a request to display a checkout page of a retailer; retrieving a user profile corresponding to a user requesting a web page; determining, based on the user profile, a plurality of products to recommend to the user; and outputting the checkout page, wherein the checkout page comprises an indication of each product of the plurality of products.

According to another broad aspect of the present technology, there is provided a method for selecting a next dialog turn, the method comprising: receiving a request to determine a next dialog turn for a conversation, wherein the request comprises a set of dialog turns that previously occurred during the conversation and a set of possible next dialog turns; determining, based on a machine learning algorithm (MLA), a predicted reward value for each dialog turn of the set of possible next dialog turns, wherein the MLA was trained using a set of previous conversation records to predict a reward value for a conversation turn; determining whether to select the next dialog turn randomly; after determining not to select the next dialog turn randomly, selecting a possible next dialog turn having a highest predicted reward value of the possible next dialog turns to be the next dialog turn; and outputting the next dialog turn.

According to another broad aspect of the present technology, there is provided a method for selecting a next dialog turn, the method comprising: receiving a request to determine a next dialog turn for a conversation, wherein the request comprises a set of dialog turns that previously occurred during the conversation and a set of possible next dialog turns; determining, based on a machine learning algorithm (MLA), a predicted reward value for each dialog turn of the set of possible next dialog turns, wherein the MLA was trained using a set of previous conversation records to predict a reward value for a conversation turn; ranking the set of possible next dialog turns based on the predicted reward value for each dialog turn; determining whether to select the highest ranked dialog turn; after determining not to select the highest-ranked dialog turn, removing a pre-determined amount of lowest-ranked dialog turns from the set of possible next dialog turns; randomly selecting one of the remaining dialog turns in the set of possible next dialog turns to be the next dialog turn; and outputting the next dialog turn.

According to another broad aspect of the present technology, there is provided a method for generating review summaries for a product, the method comprising: receiving a request for the review summaries, wherein the request comprises an indication of the product and a user profile comprising labels corresponding to a user that were selected from an ontology of labels; retrieving a set of reviews corresponding to the product, wherein each review was labelled with one or more labels from the ontology of labels; ranking each review in the set of reviews based on a number of labels from the user profile that are associated with the respective review, wherein reviews having a higher number of labels matching the user profile are ranked higher; removing a pre-determined amount of lowest-ranked reviews from the set of reviews; extracting, from remaining reviews in the set of reviews, a set of sentences; determining, for each sentence of the set of sentences, an opinion score; and selecting sentences from the set of sentences having highest opinion scores.

According to another broad aspect of the present technology, there is provided a method for labelling a set of products, the method comprising: retrieving text corresponding to each product of the set of products; determining, based on a trained model, labels to apply to the text, wherein the trained model was trained to predict labels using a set of previously labelled products; determining, for each product in the set of products, a label confidence score for the product; and outputting the set of products and the label confidence score for each product.

In some implementations of the method, the method further comprises: receiving user input modifying labels assigned to a product of the set of products; adding the product to the set of previously labelled products; re-training, based on the set of previously labelled products, the trained model, thereby generating an updated trained model; and determining, based on the updated trained model, updated labels for the set of products. Various implementations of the present technology provide a non-transitory computer-readable medium storing program instructions for executing one or more methods described herein, the program instructions being executable by a processor of a computer-based system.

In some implementations of the method, determining the labels to apply to the text comprises: extracting a set of tokens from the text; generating, for each token, a set of n-grams; determining, for each n-gram of the set of n-grams and using the trained model, a label and a label score corresponding to the respective n-gram; determining, for each token, a highest-scoring n-gram corresponding to the respective token; and selecting a label of the highest-scoring n-gram for each token as the label to apply to the respective token.

Various implementations of the present technology provide a computer-based system, such as, for example, but without being limitative, an electronic device comprising at least one processor and a memory storing program instructions for executing one or more methods described herein, the program instructions being executable by the at least one processor of the electronic device.

In the context of the present specification, unless expressly provided otherwise, a computer system or computing environment may refer, but is not limited to, an “electronic device,” a “computing device,” an “operation system,” a “system,” a “computer-based system,” a “computer system,” a “network system,” a “network device,” a “controller unit,” a “monitoring device,” a “control device,” a “server,” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (e.g., CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first,” “second,” “third,” etc. have been used as adjectives only for the purpose of allowing for distinction between the nouns that they modify from one another, and not for the purpose of describing any particular relationship between those nouns.

Additional and/or alternative features, aspects and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a block diagram of an example computing environment in accordance with various embodiments of the present technology;

FIG. 2 is a block diagram of a dialog system in accordance with various embodiments of the present technology;

FIG. 3 is a block diagram of a user interface of the dialog system in accordance with various embodiments of the present technology;

FIG. 4 is a block diagram of runtime modules of the dialog system in accordance with various embodiments of the present technology;

FIG. 5 is a block diagram of training modules of the dialog system in accordance with various embodiments of the present technology;

FIGS. 6A-C illustrate a flow diagram of a method for generating chat responses in accordance with various embodiments of the present technology;

FIG. 7 illustrates a flow diagram of a method for displaying recommended products based on a user's previous interactions in accordance with various embodiments of the present technology;

FIG. 8 illustrates a flow diagram of a method for determining a next dialog turn in accordance with various embodiments of the present technology;

FIGS. 9A-B illustrate a flow diagram of a method for determining recommended products in accordance with various embodiments of the present technology;

FIG. 10 illustrates a flow diagram of a method for training a conversation optimizer engine in accordance with various embodiments of the present technology;

FIG. 11 illustrates a flow diagram of a method for selecting a next dialog turn in accordance with various embodiments of the present technology;

FIG. 12 illustrates a flow diagram of a method for pre-processing personalized reviews in accordance with various embodiments of the present technology;

FIGS. 13A-B illustrate a flow diagram of a method for generating review summaries in accordance with various embodiments of the present technology;

FIG. 14 illustrates a flow diagram of a method for determining a predicted intent in accordance with various embodiments of the present technology;

FIG. 15 illustrates a flow diagram of a method for training a model for selecting a variant in accordance with various embodiments of the present technology;

FIG. 16 illustrates data stored in a trained model for selecting a variant in accordance with various embodiments of the present technology;

FIG. 17 illustrates a flow diagram of a method for selecting a variant in accordance with various embodiments of the present technology;

FIG. 18 illustrates a flow diagram of a method for labelling products using manual and automatic labelling in accordance with various embodiments of the present technology;

FIG. 19 illustrates a flow diagram of a method for manually labelling products in accordance with various embodiments of the present technology;

FIGS. 20A and 20B illustrate a flow diagram of a method for generating a model for labelling products in accordance with various embodiments of the present technology;

FIG. 21 illustrates a flow diagram of a method for automatically labelling products in accordance with various embodiments of the present technology;

FIGS. 22A and B illustrate a flow diagram of a method for determining product labelling confidence scores in accordance with various embodiments of the present technology;

FIG. 23 illustrates a product personalization interface in accordance with various embodiments of the present technology;

FIG. 24 illustrates a web page with a banner in accordance with various embodiments of the present technology; and

FIG. 25 illustrates a banner chat interface in accordance with various embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RANI), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that one or more modules may include for example, but without being limitative, computer program logic, computer program instructions, software, stack, firmware, hardware circuitry, or a combination thereof.

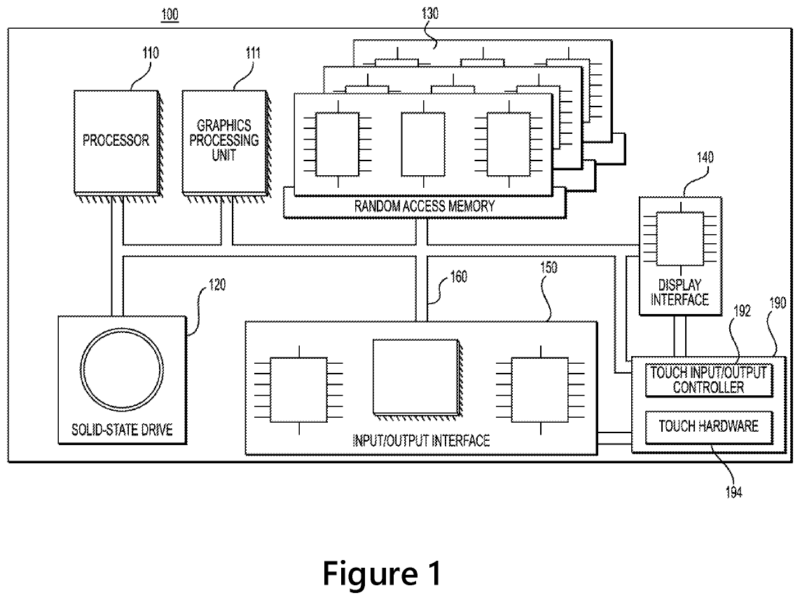

FIG. 1 illustrates a computing environment 100, which may be used to implement and/or execute any of the methods described herein. In some embodiments, the computing environment 100 may be implemented by any of a conventional personal computer, a computer dedicated to managing network resources, a network device and/or an electronic device (such as, but not limited to, a mobile device, a tablet device, a server, a controller unit, a control device, etc.), and/or any combination thereof appropriate to the relevant task at hand. In some embodiments, the computing environment 100 comprises various hardware components including one or more single or multi-core processors collectively represented by processor 110, a solid-state drive 120, a random access memory 130, and an input/output interface 150. The computing environment 100 may be a computer specifically designed to operate a machine learning algorithm (MLA). The computing environment 100 may be a generic computer system.

In some embodiments, the computing environment 100 may also be a subsystem of one of the above-listed systems. In some other embodiments, the computing environment 100 may be an “off-the-shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Those skilled in the art will appreciate that processor 110 is generally representative of a processing capability. In some embodiments, in place of or in addition to one or more conventional Central Processing Units (CPUs), one or more specialized processing cores may be provided. For example, one or more Graphic Processing Units (GPUs), Tensor Processing Units (TPUs), and/or other so-called accelerated processors (or processing accelerators) may be provided in addition to or in place of one or more CPUs.

System memory will typically include random access memory 130, but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 120 is shown as an example of a mass storage device, but more generally such mass storage may comprise any type of non-transitory storage device configured to store data, programs, and other information, and to make the data, programs, and other information accessible via a system bus 160. For example, mass storage may comprise one or more of a solid state drive, hard disk drive, a magnetic disk drive, and/or an optical disk drive.

Communication between the various components of the computing environment 100 may be enabled by a system bus 160 comprising one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wired or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example the networking interface may implement specific physical layer and data link layer standards such as Ethernet, Fibre Channel, Wi-Fi, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computing device 100 in addition to or instead of the touchscreen 190.

According to some implementations of the present technology, the solid-state drive 120 stores program instructions suitable for being loaded into the random access memory 130 and executed by the processor 110 for executing acts of one or more methods described herein. For example, at least some of the program instructions may be part of a library or an application.

### Dialog System

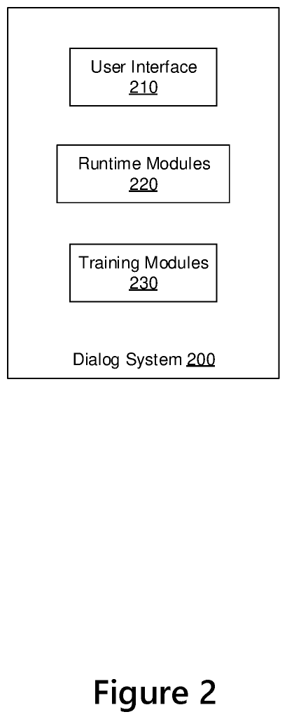

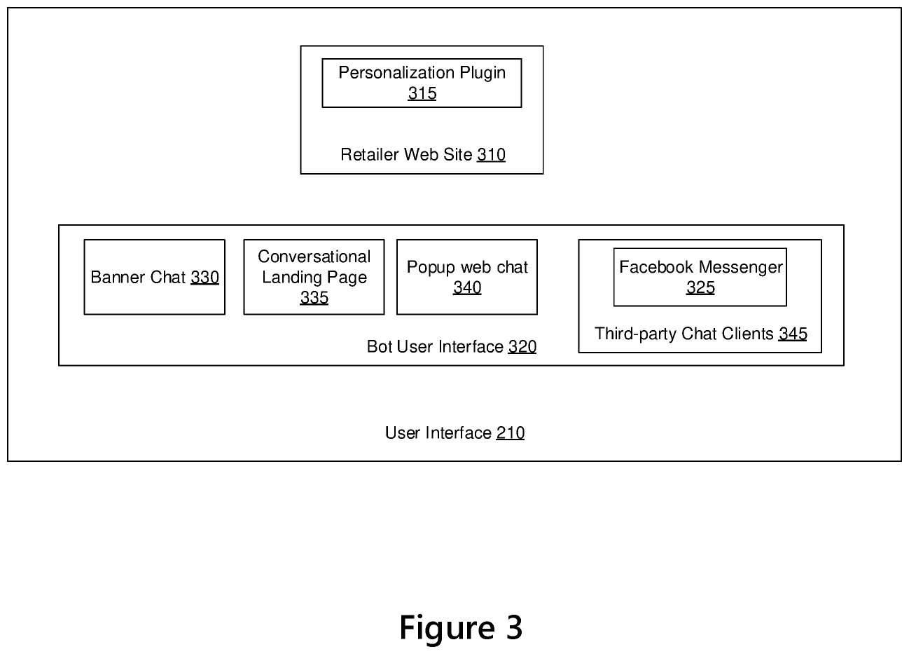

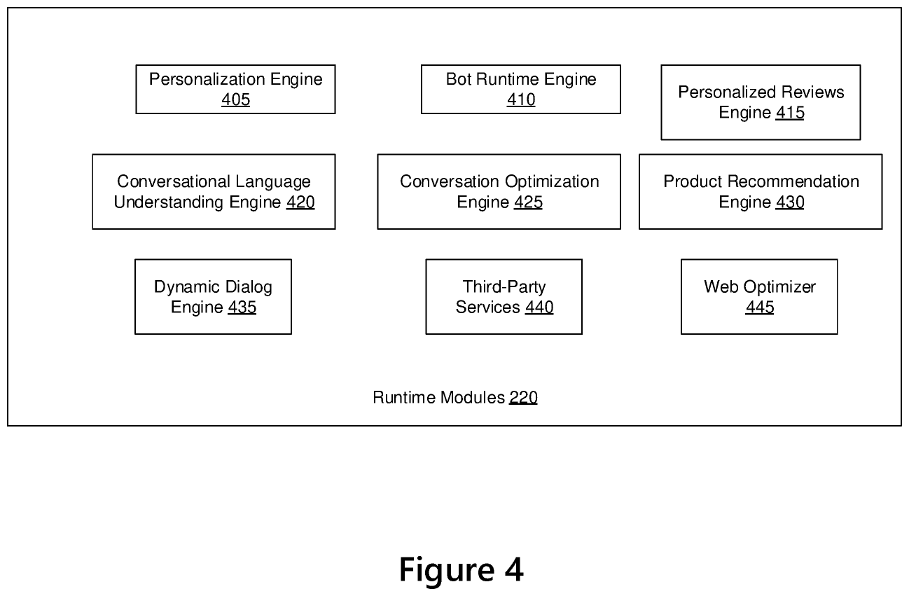

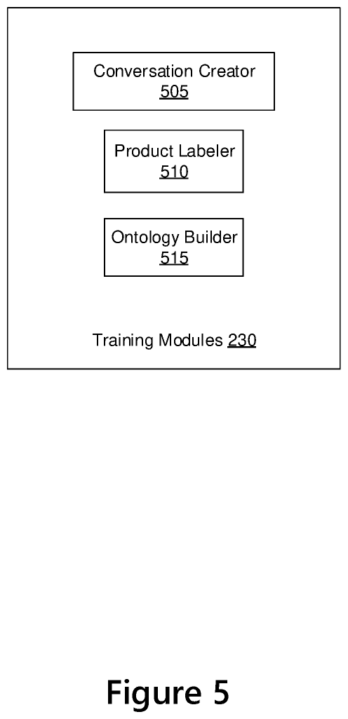

FIG. 2 is a block diagram of a dialog system 200 in accordance with various embodiments of the present technology. The dialog system 200 may be an automated dialog system for conversing with a user such as a potential customer. The dialog system 200 may recommend products to the user. The dialog system 200 may receive input from the user, such as in response to questions posed by the dialog system 200. The dialog system 200 may use the input to identify products to recommend to the user and/or dialog to output to the user. The dialog system 200 may then output the recommended products to the user. The dialog system 200 may output reviews corresponding to the recommended products. The dialog system 200 may store a user profile corresponding to the user.

The dialog system 200 may comprise various components, such as a user interface system 210, runtime modules 220, and training modules 230. The user interface system 210 may be used to interact with the user. The user interface system 210 may allow the user to enter input. The user interface system 210 may allow the dialog system 200 to output dialog and/or recommendations to the user. Each input and/or output in the dialog may be considered a dialog turn. After receiving user input via the user interface system 210, the input may be stored as a dialog turn. The runtime modules 220 may then determine an output to provide to the user as the next dialog turn.

The runtime modules 220 may comprise various modules used by the dialog system 200 to process received input and/or generate information to output. The runtime modules 220 may receive input via the user interface system 210, process the input, determine products to recommend, and/or output the recommended products. The runtime modules 220 may analyze the inventory of a seller and identify products to recommend to a customer. The runtime modules 220 may determine text and/or images to output to the user at a next dialog turn. The runtime modules 220 may generate review summaries to output to the user.

The training modules 230 may be used by an operator to train various aspects of the dialog system 200. The training modules 230 may be used to build models for generating conversations. The training modules 230 may be used to label products in the inventory of a seller. The training modules 230 may be used to define attributes of a user and/or products. These attributes may be stored as labels that are applied to the products and/or stored in a user's profile.

The dialog system 200 may be used by a retailer to assist customer's in selecting products sold by the retailer. Although described herein as being operated by a retailer, it should be understood that the dialog system 200 may be used by any other type of entity, such as a manufacturer, bank, insurance company, service provider, etc. For example the dialog system 200 may be implemented by a mobile telephone service provider to assist customers selecting a mobile service plan. In another example the dialog system 200 may be implemented by a bank to assist customers selecting a credit card. In yet another example the dialog system 200 may be implemented by an airline to assist customers booking a flight. Although the methods and/or systems described herein are described as recommending products, it should be understood that these products may be services, content, and/or any other types of items that can be recommended.

### User Interface

The user interface system 210 may comprise various components for providing a user interface for interacting with a user, such as a customer. The user interface may be provided through a bot user interface 320, such as various web chat interfaces. The bot user interface 320 may allow a user to communicate with the dialog system 200. The bot user interface 320 may include Facebook Messenger 325, a banner chat 330, a conversational landing page 335, a popup web chat 340, and/or third-party chat clients 345.

Third-party chat clients 345, such as Facebook Messenger 325, may be used for interacting with a user. The user may enter text and/or select one or more selectable elements, such as buttons with potential answers, in the third-party chat client 345. The dialog system 200 may respond to the user via the third-party chat client 345. A user may be more comfortable interacting with the dialog system 200 through a third-party chat client 345 that the user is already familiar with. Other examples of third-party chat clients include, but are not limited to, LivePerson Web Chat, Slack, and Kik Messenger.

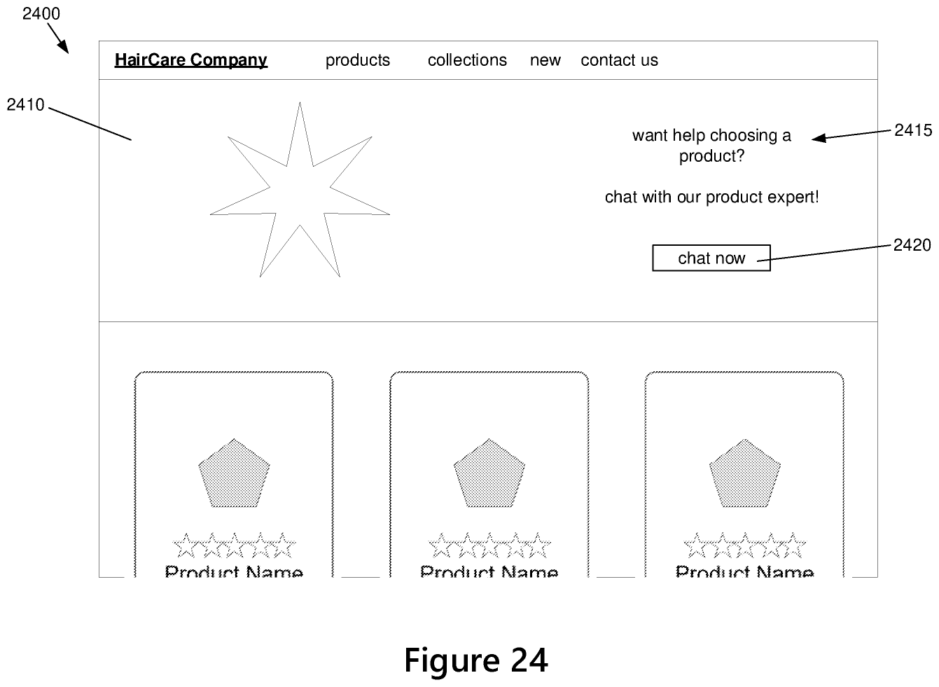

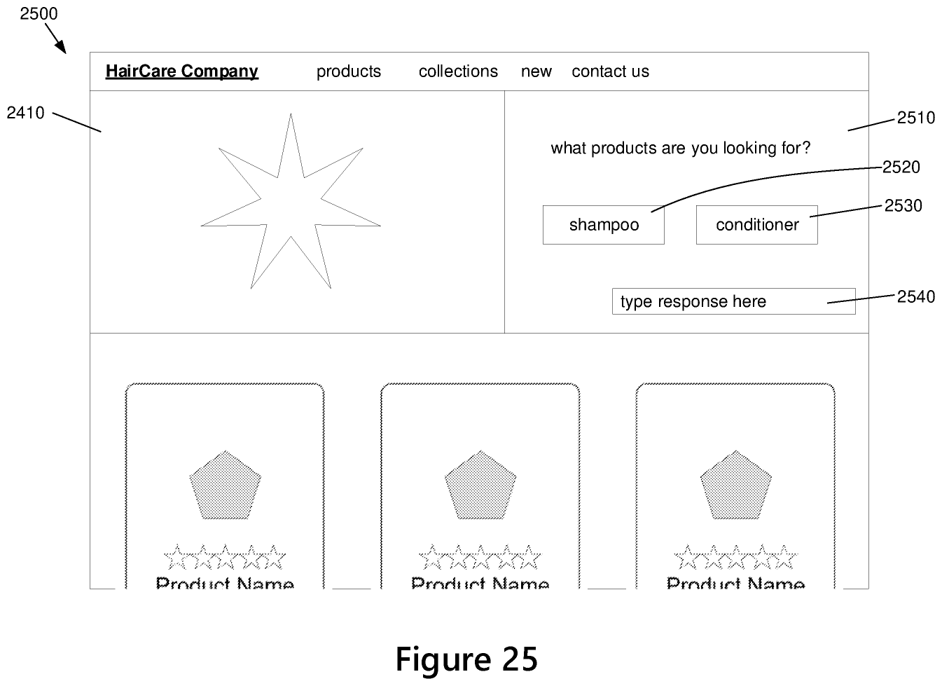

A banner chat 330 may be used for interacting with the user. The banner chat 330 may be integrated in a retailer web site 310. The banner chat 330 may allow the user to communicate with the dialog system 200 directly from the retailer web site 310. FIGS. 24 and 25, described in further detail below, illustrates an example of a banner chat 330 interface.

The bot user interface 320 may include a conversational landing page 335. The conversational landing page 335 may be a web page that is opened after the user makes a selection on the retailer web site 310. The conversational landing page 335 may be opened after other user actions, such as when a user selects an advertisement or selects an element in a social media platform. The user may select, on the retailer web site 310, to communicate with a product recommendation system. The user may then be forwarded to the conversational landing page 335.

A popup web chat 340 may be displayed on the retailer web site 310. The popup web chat 340 may be overlaid on the retailer web site 310. The popup web chat 340 may provide a chat interface for communicating with the dialog system 200 without the user having to leave the retailer web page 310.

Each of the bot user interfaces 320 may be integrated in a retailer web site 310. The retailer web site 310 may be a web page that offers goods for sale and/or advertises goods. The retailer web site 310 may be a web page operated by a manufacturer, retailer, distributor, etc. In order to integrate the bot user interface 320 into the retailer web site 310, the retailer web site 310 may integrate a personalization plugin 315. The personalization plugin 315 may cause the bot user interface 320 to be displayed on the retailer web site 310. The personalization plugin 315 may be integrated as a JavaScript and/or cascading style sheet (CSS) library that is integrated in the retailer web site 310.

### Runtime Modules

The runtime modules 220 are used by the dialog system 200 to process text received via the user interface system 210 at each dialog turn, and to determine outputs to provide to the user via the user interface system 210.

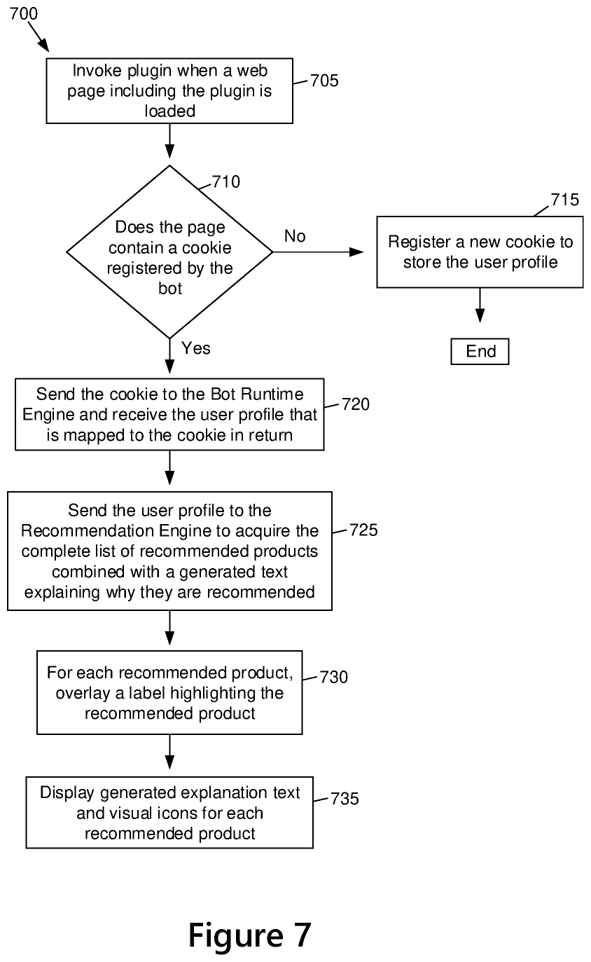

The personalization engine 405 may personalize a web page or other user interface based on a user profile. The personalization engine 405 may enable a retailer to highlight and describe recommended products in personalized ways to end users based on the information gathered during a conversation. FIG. 7 and the method 700, described in further detail below, illustrate an example of how the personalization engine 405 may personalize a web page. The personalization engine 405 may indicate on the web page which products are recommended for the user. The personalization engine 405 may display text, icons or other images, and/or videos explaining the reasons why particular products were recommended for the user.

The user profile may be maintained by a retailer and/or any other entity. The user profile may be associated with a user account of the user and/or a cookie stored on a device used by the user. When the user requests the web page, the web page may be personalized based on the user profile. Product recommendations may be displayed to the user based on the user profile. Products and/or categories may be displayed to the user based on the user profile.

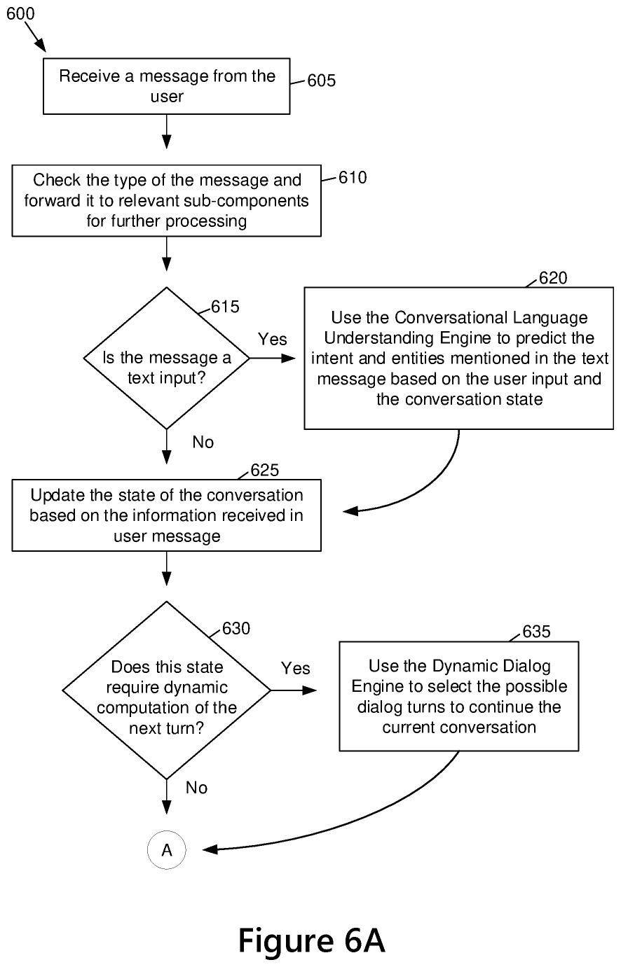

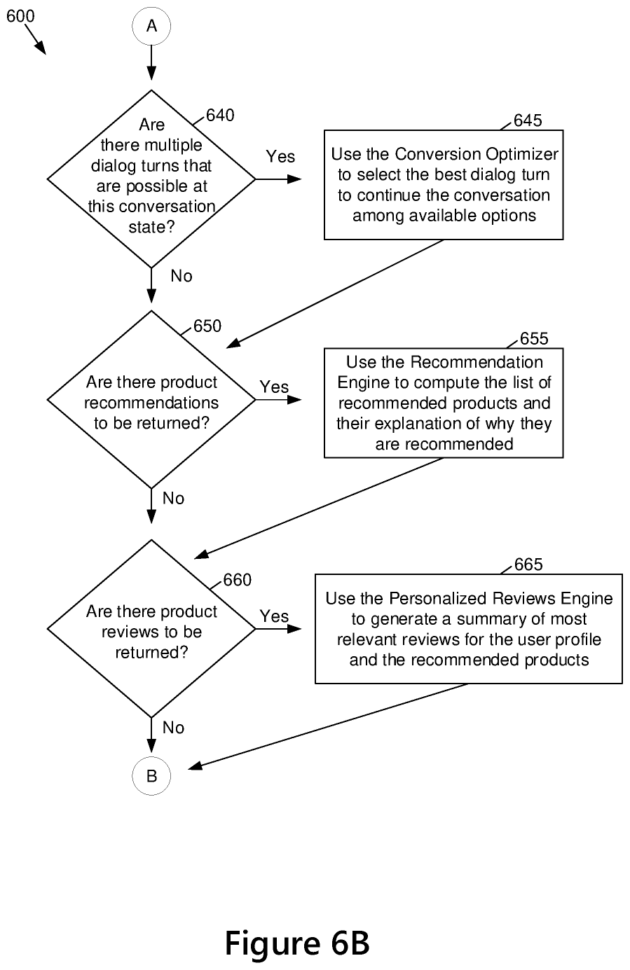

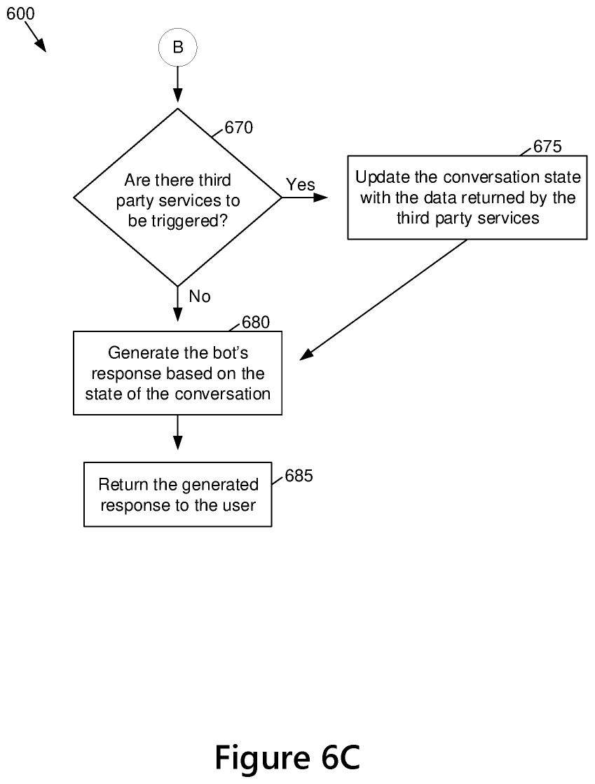

The bot runtime engine 410 may be used to maintain a dialog with the user. The bot runtime engine 410 may receive input from the user, process the input, and determine a response to be output to the user. FIGS. 6A to 6C and the method 600, described in further detail below, illustrate an example of how the bot runtime engine 410 may maintain a dialog with a user.

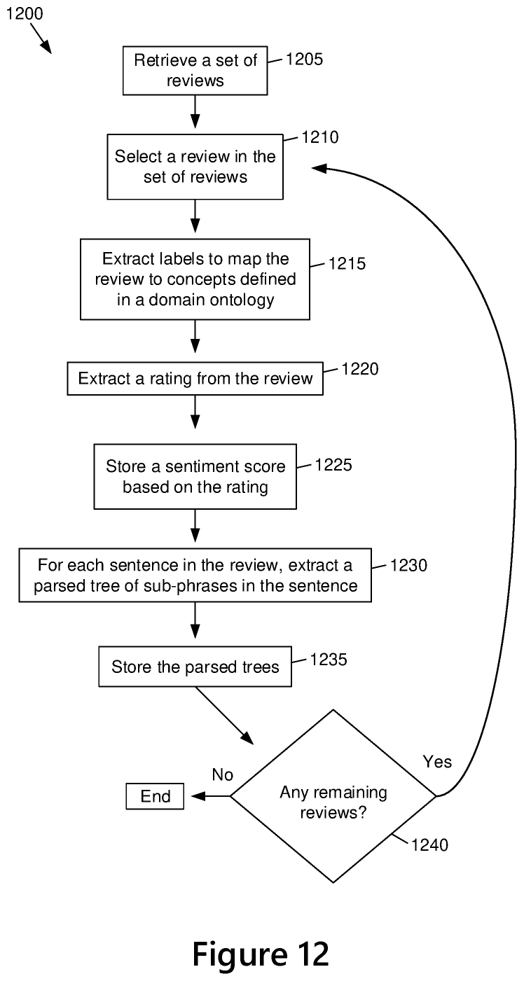

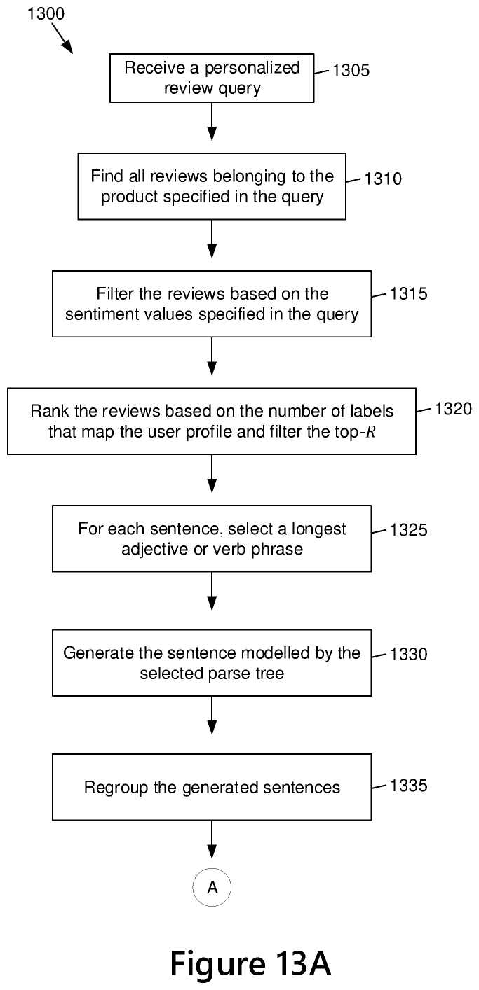

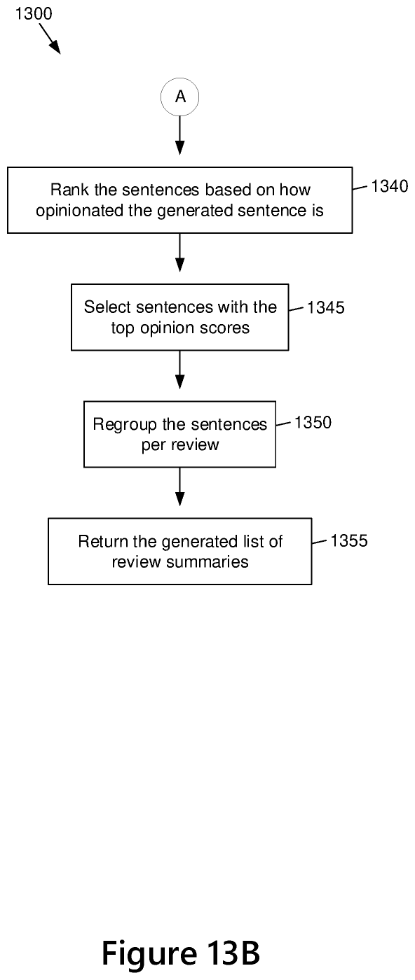

The personalized reviews engine 415 may be used to generate a review summary to be output to the user. The personalized reviews engine 415 may retrieve reviews corresponding to products to be recommended to the user. The personalized reviews engine 415 may retrieve review data from a labelled product reviews database. The personalized reviews engine 415 may parse the reviews. The parsed reviews may be ranked based on a relevance of the review to the user's profile. The ranked reviews may be used to generate a review summary to be output to the user. FIGS. 12, 13A, 13B, and the methods 1200 and 1300, described in further detail below, illustrate an example of how the personalized reviews engine 415 may parse reviews and generate a review summary.

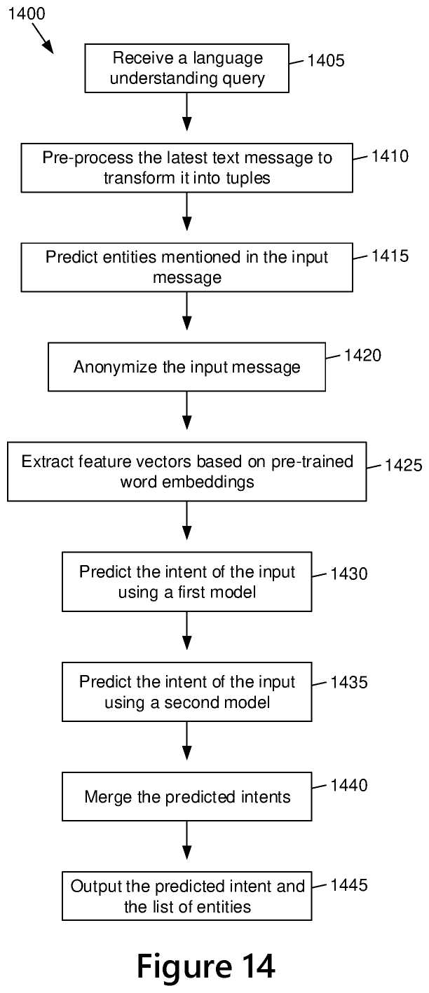

The conversational language understanding engine 420 may be used to predict an intent and/or list of entities in a received text input. The conversational language understanding engine 420 may use one or more models to predict the intents and/or entities corresponding to the text input. The predicted intents and/or entities may then be used by the dialog system 200 to determine a response to the user input. FIG. 14 and the method 1400, described in further detail below, illustrate an example of how the conversational language understanding engine 420 may process text input received from a user.

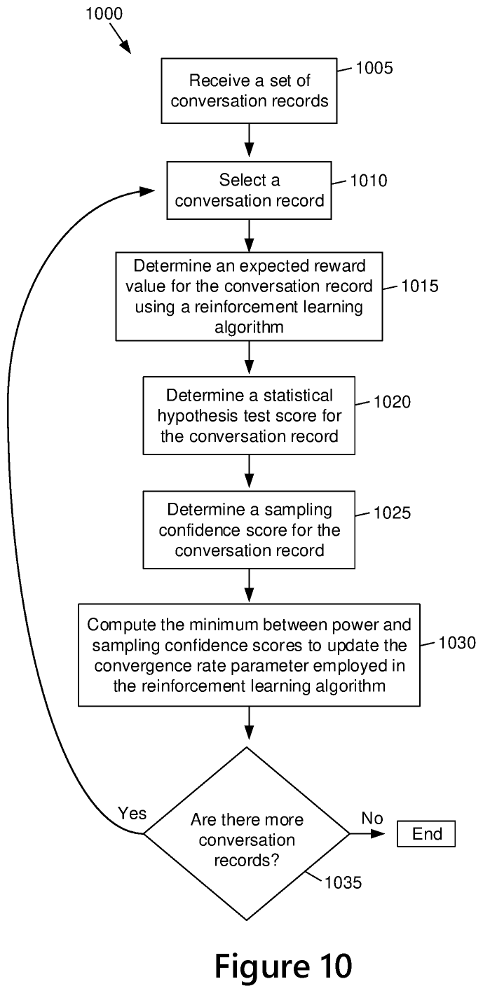

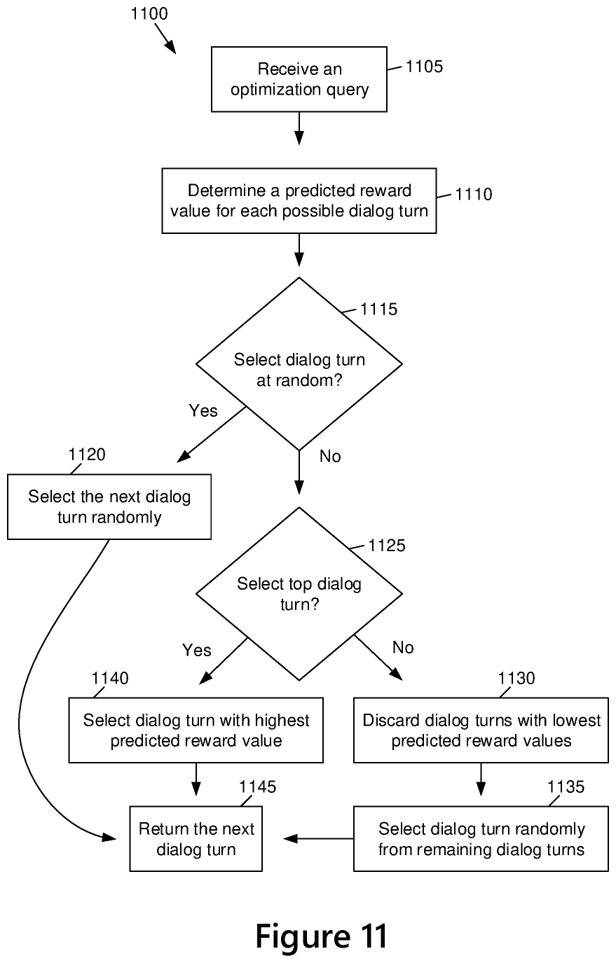

The conversation optimization engine 425 may be used to predict an output that is most likely to lead to a pre-determined goal and/or a list of pre-determined goals. The conversation optimization engine 425 may be configured to optimize for multiple goals on the list of pre-determined goals. The conversation optimization engine 425 may be configured to optimize for multiple goals, even when some of the goals are competing with each other. The pre-determined goal may be selected by the operator of the dialog system 200 and/or the retailer implementing the dialog system 200. The pre-determined goal may be for the user to purchase one or more products, for the user to enter their e-mail address, to collect data regarding the user, and/or any other goal. The pre-determined goal may be defined by the operator and stored in a bot template model. The conversation optimization engine 425 may analyze previous dialogs to determine how effective each dialog turn was. During a conversation, the conversation optimization engine 425 may be sent the current state of the conversation. The conversation optimization engine 425 may then select a next dialog turn based on how effective the dialog turn is predicted to be. FIGS. 10, 11, and methods 1000 and 1100, described in further detail below, illustrate an example of how the conversation optimization engine 425 may process prior dialogs and predict the effectiveness of dialog turns.

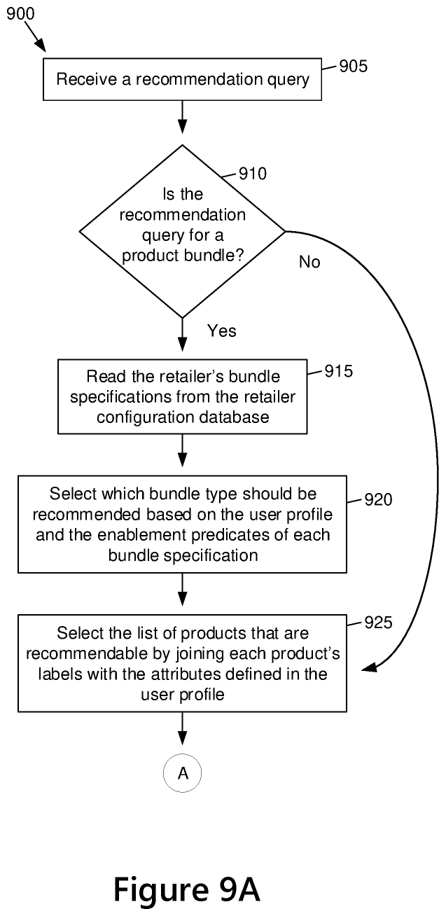

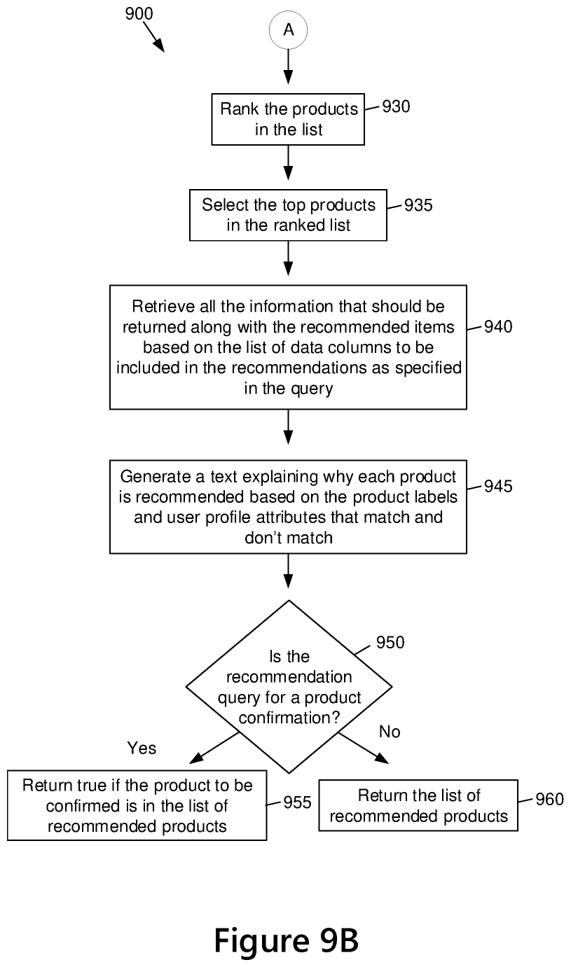

The product recommendation engine 430 may be used to recommend one or more products to the user. The product recommendation engine 430 may receive a user profile, such as a user profile of a user engaged in a dialog with the dialog system 200. The product recommendation engine 430 may determine one or more products to be recommended to the user based on the user's profile. FIGS. 9A, 9B, and the method 900, described in further detail below, illustrate an example of how the product recommendation engine 430 may determine which products to recommend to a user.

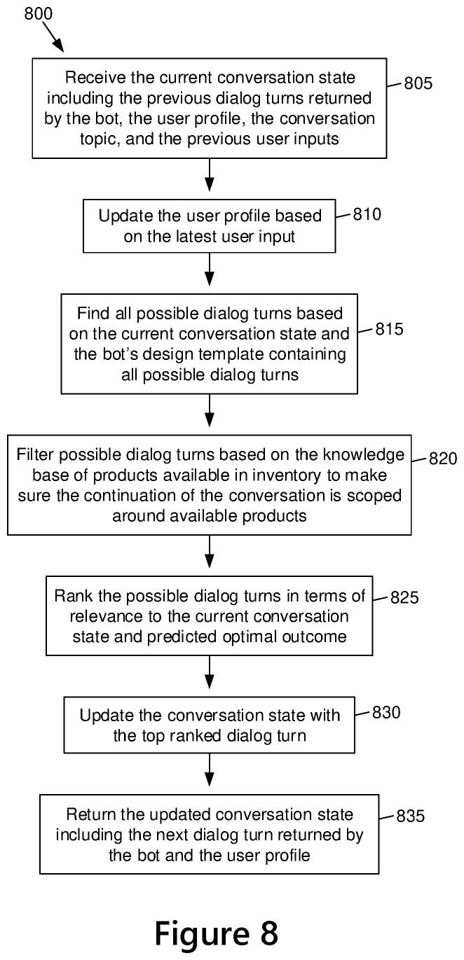

The dynamic dialog engine 435 may receive a current conversation state of a conversation and determine a next dialog turn. The dynamic dialog engine 435 may update the user profile based on the latest user input in the conversation state. The dynamic dialog engine 435 may determine all possible next dialog turns and rank the dialog turns. The top ranked dialog turn may be selected as the next dialog turn. FIG. 8 and the method 800, described in further detail below, illustrate an example of how the dynamic dialog engine 435 may determine a next dialog turn.

Third-party services 440 may include any external services for interacting with a user. Some examples of third party services 440 include a system for engaging in a dialog with a human agent and/or a system for managing user profile data. A user may indicate that they wish to have a dialog with a human agent rather than with the dialog system 200. The dialog system 200 may interact with a third party service 440 to connect the user to a human agent. The user may be forwarded to a human agent automatically in some instances. If the dialog system 200 is unable to respond to the user's request, such as if the dialog system 200 cannot interpret the user's input, the dialog system 200 may interact with a third party service 440 to connect the user to a human agent. The user may continue using the same interface that was previously used for interacting with the dialog system 200, but the dialog may now be with a human agent rather than responses generated by the dialog system 200.

A retailer employing the dialog system 200 may wish to have data collected by the dialog system 200 transmitted to the retailer's customer relationship management (CRM) system. The dialog system 200 may interact with a third party service 440, such as by interacting directly with the CRM system or by interacting with a system in communication with the CRM system to provide collected data to the CRM system.

Web optimizer 445 may select and/or display a variant of a web page. When a user requests a web page, multiple variants of the web page may be available for displaying to the user. The web page may contain configurable elements, and there may be multiple variants of the configurable elements that can be selected for displaying to the user. For example, the web page may include a banner, and there may be multiple banner variants available. When the user requests the web page, one of the banner variants may be selected and rendered with the web page.

The web optimizer 445 may train a model for selecting which variant will be displayed. The model may be output in executable code, such as JavaScript. When the web page is loaded the executable code may select which variant will be rendered. The user's response to the variant may be measured and used to further train the model. By periodically retraining the model for variant selection over a period of time with updated results, the model may cause the web page to be adapted for changing user preferences.

### Training Modules

The training modules 230 may be used by an operator to create and/or edit various templates and other information used by the dialog system 200.

The conversation creator 505 may be used by the operator to enter various conversation templates. The conversation creator 505 may allow the operator to define responses to various inputs that may be received from a user. The operator may use the conversation creator 505 to define various possible dialog turns that may be output to a user. The conversation creator 505 is a user interface for conversation designers to design the possible outcomes of a conversation with end-users. The output of the conversation design may be stored in a bot template model. Possible inputs that can be output to the users and/or received by the dialog system 200 may be defined using the conversation creator 505 and stored in the bot template model.

The product labeler 510 may be used to label products sold by the retailer. An ontology of labels for products may be defined based on hierarchical product category information associated with the products, which may be found on the retailer's web page, descriptions of the products, reviews of the product, and/or any other text corresponding to the products. Labels may be added to the ontology, removed from the ontology, and/or otherwise modified by a human operator. The labels may be in a hierarchical format, with root labels having associated child labels, recursively. The ontology may be defined using the ontology builder 515. The ontology builder 515 may allow an operator to define various labels. The labels may comprise user properties, product properties, and/or any other information related to the products. A name may be entered for each of the labels. A type of label may be selected, such as binary, multi-select, single select, etc. Labels may be assigned children and/or parent labels that are related. The labels may be assigned as either a filter label or a ranking label. Filter labels may be used to filter out products to be recommended. For example the label “vegetarian” may be defined as a filter label. If the user indicates that they are vegetarian, then all products that are not labeled vegetarian may be filtered out and not recommended to the user. In this case the user would likely not be interested in any products that are not vegetarian. Ranking labels may indicate features that are preferred. For example the label “spicy” may be defined as a ranking label. If a user's profile includes the label “spicy”, products that are also labelled “spicy” may be more highly ranked and more likely to be recommended to the user. Products that are not labelled “spicy” might still be recommended to the user because the label was defined as a ranking label. If the label had been defined as a filter label, products that are not labelled “spicy” might be filtered out and not recommended to the user.

Labels for a product may be determined based on any text associated with the product, such as a description of the product and/or reviews of the product. Labels may be manually defined by an operator. An operator may manually review each product's labels using the product labeler 510. The product labeler 510 may allow the operator to add and/or remove labels from each product. An auto-labelling model may also be used to determine labels for a product. The auto-labelling model may receive data available in the retailer's inventory, including product descriptions, reviews, categories, etc. The auto-labelling model may automatically label products using labels in the ontology, such as by using an MLA. The labels that are automatically assigned can later be curated manually by an operator using the product labeler 510 in order to correct the mistakes that may have been introduced by the MLA. These corrections may be fed back to the auto-labelling model to continuously improve the quality of the MLA.

### Bot Runtime Engine

FIGS. 6A-C illustrate a flow diagram of a method 600 for generating chat responses in accordance with various embodiments of the present technology. All or portions of the method 600 may be executed by the bot runtime engine 410. In one or more aspects, the method 600 or one or more steps thereof may be performed by a computing system, such as the computing environment 100. The method 600 or one or more steps thereof may be embodied in computer-executable instructions that are stored in a computer-readable medium, such as a non-transitory mass storage device, loaded into memory and executed by a CPU. The method 600 is exemplary, and it should be understood that some steps or portions of steps in the flow diagram may be omitted and/or changed in order.

At step 605 a message may be received from a user. The message may include any type of user input, such as a text input, a photograph, a selection, a voice command, etc. The message may be received in response to a question output to the user. The message may indicate a type of product that the user is seeking and/or a need that the user would like the product to fulfill. For example the message may indicate that the user would like a product that treats a specific skin condition. The message may be received through one of the bot user interfaces 320, which may be integrated in a retailer web site 310. For example the user may visit a retailer web site 310 and be prompted to enter the message in a bot user interface 320. The message may correspond to a dialog turn.

At steps 610 and 615 the type of message received at step 605 may be determined. After determining the type of message, the message may be forwarded to various components corresponding to that message type for further processing, such as one or more of the runtime modules 220. The type of message may be determined based on a format of the message and/or content of the message. The format of the message may be a text input, video input, photo input, voice input, selection of a selectable element, and/or any other type of input. One or more selectable elements having pre-filled responses may be displayed to a user, and the user may select one or more of the selectable elements as input. For example the dialog system 200 may ask the user to select colors that they like and then display multiple selectable buttons, where each button represents a color. The pre-filled responses may be defined in the bot template model corresponding to the dialog.

If the type of message is a text input, at step 620 the intent of the message may be determined and/or predicted. The entities mentioned in the text input may be determined and/or predicted. The intent and entities may be predicted based on the user input and/or the current conversation state. One or more MLAs may be used to predict the intent and/or entities. The MLA may receive the message and/or the conversation state as input and output a predicted intent and/or predicted entities. The method 1400, described in further detail below and in FIG. 14, may be used to predict the intent and/or entities mentioned in the text input.

After predicting the intent and/or entities, or if the message is determined at step 615 to not contain text input, at step 625 the state of the conversation may be updated based on the information received in the user message. All or a portion of the message may be stored in the conversation state. The predicted intent and/or predicted entities may be stored in the conversation state. The conversation state may comprise a record of each dialog turn in the conversation. The conversation state may comprise a user profile of the user engaged in the conversation.

At step 630 a determination may be made as to whether a dynamic computation should be used to determine the next dialog turn of the dialog. A bot template may be used to manage the dialog. The bot template may correspond to the retailer implementing the dialog system 200. When designing a bot template, such as using the conversation creator 505, the operator may select whether dialog turns are statically linked to next dialog turns or whether dynamic computation should be used to determine the next dialog turn. By statically linking the dialog turns, the operator may have complete control over the dialog because the operator will explicitly select the order in which the dialog turns occur. If the operator selects dynamic dialog engine, the dialog turns may be selected as the dialog occurs rather than being pre-determined. This may offer a more dynamic and personalized experience to the user. By using the dynamic dialog engine to select dialog turns, the user experience may be customized based on the products that are available in the retailer's inventory. For each dialog turn that the operator creates in the bot template, the operator may be able to select whether the next dialog turn should be determined statically or dynamically.

If a dynamic computation should be performed for the next turn, at step 635 the dynamic dialog engine 435 may be used to determine possible dialog turns to continue the conversation. The dynamic dialog engine 435 may receive the current conversation state as input and output an updated conversation state including a next dialog turn. The method 800, described in FIG. 8 and in further detail below, describes how the dynamic dialog engine may determine the possible next dialog turns.

After the possible dialog turns have been determined at step 635, or if dynamic computation was determined to not be used at step 630, the method 600 may continue to step 640. At step 640 a determination may be made as to whether there are multiple dialog turns that are possible at this conversation state. For example if more information is to be collected from the user, then a determination may be made that there are multiple different dialog turns that can be used to collect that information.

If there are multiple dialog turns, at step 645 a next dialog turn may be selected. The next dialog turn may be selected from available options, such as those determined at step 635. The conversation optimization engine 425 may be used to select the next dialog turn. The next dialog turn may be selected to maximize a predicted likelihood that the user will continue the conversation purchase a recommended product, and/or perform any other predetermined goal such as providing their email address. The next dialog turn may be selected based on the available of products, such as to ensure that any products that will be recommended are available for purchase.

If there are no further dialog turns at step 640, or after a next dialog turn has been selected at step 645, at step 650 a determination may be made as to whether there are any product recommendations to return. Recommendations may be made at any point during a dialog. The bot template model may indicate at what times during the dialog recommendations are to be returned. The operator designing the bot template may select when the recommendations are to be returned. Typically recommendations are returned at the end of a dialog. Recommendations may be returned during a dialog and followed by a dialog turn with follow-up questions regarding the recommendations. The recommendations may then be refined based on the responses to the follow-up questions. Whether there are any product recommendations to return may be determined based on the conversation state.

If there are products to be recommended, at step 655 a list of recommended products may be determined. An explanation may be determined for each of the recommended products. The explanation may include a description of why the respective product is being recommended. The product recommendation engine 430 may determine the list of recommended products and/or the explanations.

After the list of recommended products has been determined at step 655, or if there were no products to recommend, at step 660 a determination may be made as to whether there are any product reviews to be returned. A query may be performed to determine whether there are any available reviews corresponding to products in the list of recommended products determined at step 655.

If there are reviews to be returned at step 660, at step 665 a summary of reviews may be generated. The available reviews may be ranked based on their relevance to the user profile and/or the recommended products. One or more of the highest ranked reviews may be selected, which may be the reviews predicted to be the most relevant to the user. The personalized reviews engine 415 may be used to determine the reviews and/or generate the summary of the reviews.

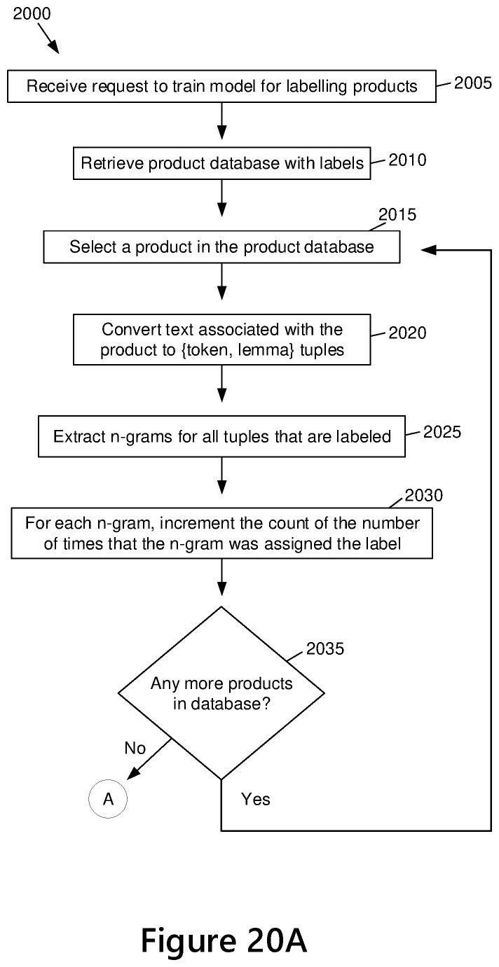

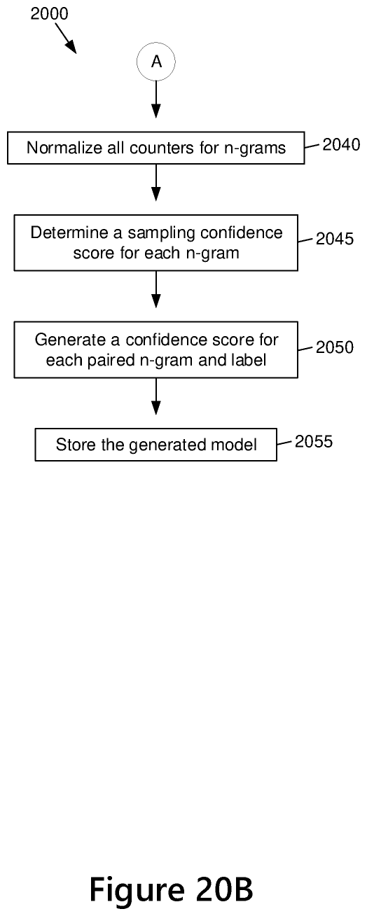

Labels may be determined for each of the reviews. The reviews may be labelled using an MLA, such as an MLA generated using the method 2000 which is described below and in FIG. 20. A set of labels corresponding to the user may be determined. The labels may be stored in the user's profile. For each review, a count may be done to determine the number of labels corresponding the user that have been applied to the review. The reviews may be ranked based on how many labels corresponding to the user have been applied to the review. Reviews that have more of the user's labels may be ranked higher, as those reviews are likely to be more relevant to the user. The reviews may be ranked based on how relevant they are to a user's labels. The labels for a review may be compared to the labels in a user's profile. The amount of labels that the user's profile has in common with the review may be determined for each review, and the reviews may be ranked based on how many labels they have in common with the user's profile. The product recommendation engine 430 may rank the reviews based on how relevant they are to the user.

After generating the summary of reviews at step 665, or if there were no reviews to be returned at step 660, the method 600 may continue to step 670. At step 670 a determination may be made as to whether there are any third party services to be triggered. The bot template model may indicate whether, at each conversation turn, a third party service should be triggered. When designing the bot template model, an operator may select, for each conversation turn, whether a third party service should be triggered. The bot template model may indicate one or more conditions that, when satisfied, trigger calling a third party service.

If there are third party services to be triggered, at step 675 one or more third party services may be triggered. The current conversation state may be transmitted to, or otherwise shared with, the third party services. The conversation state may be updated based on data returned by the third party services.

After the third party services have returned data, or if there were no third party services to be triggered, at step 680 a response to be output to the user may be generated. The response may comprise, text, video, images, and/or other types of media. The response may comprise product recommendations and/or reviews. The response may comprise one or more questions to ask the user. The response may comprise one or more selectable elements to be returned to the user, such as a list of options where the user may select one or more of the options.

At step 685 the generated response may be output to the user. The response may be output by one of the bot user interfaces 320. The response may be output in a web chat interface. The user may enter additional input, at which point the method 600 may return to step 605. In this manner the bot and the user may maintain a dialog and one or more products may be recommended to the user based on the dialog. The response may include text, images, videos, sounds, and/or any other type of content.

### Personalization Engine

A user's prior interactions with a web page and/or the dialog system 200 may be stored in a user profile. Upon visiting the web page of the retailer, the user profile may be retrieved and used to recommend products to the user.

FIG. 7 illustrates a flow diagram of a method 700 for displaying recommended products based on a user's previous interactions in accordance with various embodiments of the present technology. All or portions of the method 700 may be executed by the personalization engine 405 and/or personalized reviews engine 415. In one or more aspects, the method 700 or one or more steps thereof may be performed by a computing system, such as the computing environment 100. The method 700 or one or more steps thereof may be embodied in computer-executable instructions that are stored in a computer-readable medium, such as a non-transitory mass storage device, loaded into memory and executed by a CPU. The method 700 is exemplary, and it should be understood that some steps or portions of steps in the flow diagram may be omitted and/or changed in order.

At step 705 a plugin may be invoked when a web page including the plugin is loaded. A user may browse to the web page, which may be a retailer web site 310. The plugin may be the personalization plugin 315. The plugin may be executed by the user's browser. The plugin may be executed by a server hosting the retailer web site 310 and/or a server in communication with the host of the retailer web site 310.

At step 710 a determination may be made as to whether the web page contains a cookie registered by the bot. When the user first visits the web page, or subsequently visits the web page, a cookie may be stored locally by the user's browser. If the user's browser is storing a cookie corresponding to the web page, the cookie may be retrieved and transmitted to the server operating the web page. The web page may contain a cookie registered by the bot if the user visiting the web page has previously visited the web page and/or visited another related web page. The cookie may be associated with a user profile corresponding to the user. The user profile may contain a browsing history of the user, purchasing history of the user, conversation history of the user, any other previous interactions between the user and the retailer's web page and/or other data pertaining to the user.

If the web page does not contain a cookie registered by the bot, a new cookie may be registered. The cookie may be stored locally by the user's browser. A user profile may be generated for the user and stored. The cookie may comprise a unique identifier corresponding to the user profile. After registering the cookie at step 715, the method 700 may then end.

If the page does contain a cookie registered by the bot, at step 720 a user profile associated with the cookie may be retrieved. All or a portion of the cookie may be transmitted to the bot runtime engine 410. The bot runtime engine 410 may receive the cookie, determine a user profile mapped to the cookie, and return the user profile. The user profile may be mapped to the cookie, such as by storing the user profile in a database entry and associating the database entry with an identifier in the cookie. The user profile may include labels assigned to the user. The labels may have been determined based on user interactions, such as the user's responses to dialog questions. The labels may be included in an ontology of labels. Products in a product database and/or user reviews may be assigned labels from the same ontology of labels.

At step 725 the user profile may be used to determine a list of recommended products. The list may comprise one or more products recommended based on the user profile. The list may comprise generated text explaining why each of the recommended products was recommended.

To determine which products to recommend, the user profile may be transmitted to the product recommendation engine 430. The product recommendation engine 430 may analyze properties in the user profile and determine which products to recommend to the user. The product recommendation engine 430 may return the list of recommended products and/or the generated text explaining why the products were recommended.

At step 730 an indication of the recommended products may be output to the user. Some or all of the recommended products may be displayed to the user on a web page, in a mobile application, etc. For each recommended product that is displayed, a label, visual icon, badge, and/or other indication highlighting the recommended product may be overlaid on the recommended product, such as on an image of the recommended product. Various other methods may be used to indicate that a product was recommended, such as by enlarging the images of recommended products, displaying products that were not recommended in grayscale, or removing products from the page that were not recommended.

At step 735 the generated explanation text may be displayed for each recommended product. The recommendation text may be displayed with the indications displayed at step 730. The generated text for a product may be displayed when a user selects the product, such as by hovering over the product with their mouse pointer. The generated explanation text for a recommended product may indicate why a recommended product was selected for the user. The generated explanation text may indicate needs that were input by the user during a conversation, any other relevant information input by the user, and/or other contextual information regarding the user that was used when selecting the recommended product. By displaying recommended products and/or explanations for the recommendations, a user may be more likely to purchase a product displayed on the web page.

In some instances, the recommended products may be displayed on a shopping cart page of the retailer's web page. When the user accesses their shopping cart, recommended products may be displayed in a banner or any other format. In some instances, the recommended products may be displayed on a web page that is not maintained by the retailer. An advertisement may be displayed, such as a banner advertisement, that includes recommended products. The advertisement may be displayed on any web page.

### Dynamic Dialog Engine

FIG. 8 illustrates a flow diagram of a method 800 for determining a next dialog turn with various embodiments of the present technology. All or portions of the method 800 may be executed by the dynamic dialog engine 435. In one or more aspects, the method 800 or one or more steps thereof may be performed by a computing system, such as the computing environment 100. The method 800 or one or more steps thereof may be embodied in computer-executable instructions that are stored in a computer-readable medium, such as a non-transitory mass storage device, loaded into memory and executed by a CPU. The method 800 is exemplary, and it should be understood that some steps or portions of steps in the flow diagram may be omitted and/or changed in order.

At step 805 a current conversation state may be received. The current conversation state may include previous dialog turns. The previous dialog turns may comprise dialog that was output to the user. The current conversation state may include all or a portion of the user profile. The current conversation state may include previous user inputs, such as previous text input and/or other types of input received from the user. The current conversation state may include a conversation topic and/or multiple conversation topics. A conversation topic may be a specific product identifier, a certain category of products, and/or a certain category of user needs or preferences. The conversation topic may be empty if the conversation does not have any particular topics, in which case the conversation may cover all available topics.

A product database may be retrieved at step 805 and/or instructions for accessing a product database may be received at step 805. The products in the database may have been labelled. The product database may indicate which products are available for purchase, such as products that are in-stock. The product database may be a retailer's product database or may be updated based on a retailer's product database. The product database may be updated in real-time or near real-time to indicate whether individual products are available at the retailer. For example if a retailer runs out of stock of a product, the product database may indicate that the product is no longer available.

At step 810 the user profile may be updated based on received user input. The received user input may be stored in the user profile. If input is received that contradicts the user profile, the previous data in the user profile may be overwritten. The received user input may be mapped to labels in the user profile. Data may be extracted from the input received from the user, and the extracted data may then be stored in the user profile and associated with a label in the user profile. For example, if a user states “I have acne” during the dialog, the term “acne” may be extracted and determined to correspond to an “acne” label in the user's profile. The user's profile may be updated to indicate that “acne=true.”

At step 815 possible next dialog turns based on the current conversation state may be found. The possible next dialog turns may be found based on the current conversation state and/or a template comprising possible dialog turns. The template may comprise an operator-specific template for the dialog system 200. The template may comprise a template of all possible dialogues that can be generated. The possible dialog turns in the template may be filtered based on the current conversation state to determine a list of possible next dialog turns.

The template may contain a list of questions that can be asked. The list of questions may be ranked, where the highest-ranked question is the preferred question to ask. Each question may be attached to a label and may have different candidate answers related to that label. The question may be a binary question (yes/no) that confirms whether the user should be assigned a label or not. For example the question may be “Are you concerned with wrinkles?”. In this example, if the user answers yes, then the “wrinkles” label may be added to the user's profile. The question may be a single-answer question where the user can select only one answer among multiple given labels. For example, a question could be attached to the root label “Skin Type” (e.g. what is your skin type?) and may have “Dry”, “Oily” and “Combination” as possible answers. In this example, the user may select either “Dry,” “Oily,” or “Combination,” and the corresponding label may be applied to the user's profile. The question may be a multi-answer question, which is similar to a single-answer question except the user may select one or more answers. For example a multi-answer question may be “What aging signs are you most concerned with?” and the possible answers may be “Wrinkles,” “Radiance,” and “Crow's Feet”. In this example the user may be able to select any combination of the possible answers, such as both “Wrinkles” and “Crow's Feet.” Any other type of question may be used.

The template may contain custom dialog turns. The custom dialog turns might always be executed without going through any filtering operation. For example the template may indicate that recommendations should be displayed to the user, or the template may include a question asking for the user to enter their email address. These dialog turns might always be displayed during the conversation, regardless of the user's interactions during the dialog.

The possible dialog turns in the template may be filtered to determine potential next dialog turns. The dialog turns that have already been displayed may be filtered out. Some dialog turns may be marked as being possible to be displayed multiple times (e.g. product recommendations or explanations). Those marked dialog turns might not be filtered out even if they have already been displayed. Questions which have answers that have already been given by the user may be filtered out. For example, if a user has already indicated that they have dry skin with a response that they entered, then a question asking for the user's skin type may be filtered out. If the conversation relates to a product confirmation, such as when a user has asked to confirm that a specific product will be suitable for the user's requirements, dialog turns not relating to the specific product may be filtered out.

The answers to each question may be analyzed to determine whether any potential answers and/or questions should be filtered out. If the user has already given an answer then that answer may be filtered out as a possible answer that is displayed. If there are no available products corresponding to an answer, that answer may be filtered out. For example if a potential answer to a question is the label “radiance”, but there are no available products that match this label, then the label “radiance” may be removed as a potential answer to a question. After filtering out answers to questions, some questions might not have any remaining answers (i.e. all the possible answers to the question have been filtered out). Those questions that have no possible answers may be filtered out so that they are not presented to the user.

The template may contain a flow description which depicts the preferred order in which the questions should be asked to the user. The list of possible next questions may first be selected from that flow description, and then the list of possible next questions may be passed through the filtering mechanism described above. The first question found in the flow description that was not eliminated by the above filtering process may be selected as the next dialog turn.

At step 815, the next dialog turns may be found based on the conversation topic if the conversation topic is specified in the current conversation state. The conversation topic may be used to filter the questions and dialog turns that may be selected for the conversation. If the topic is a specific product identifier, then only the questions and dialog turns that are relevant to confirm whether that given product is recommendable for the user may be selected as the possible next dialog turns. If the topic is a specific product category, then only the questions and that are relevant to make recommendations in that given product category may be selected as the possible next dialog turns. If the topic is a specific set of user needs or preferences, then only the questions that are relevant to that set of needs and preferences may be selected as the possible next dialog turns.

At step 820 the possible next dialog turns determined at step 815 may be filtered based on which products are available in inventory. In order to recommend products that are currently available, the dialog turns associated with products that are currently unavailable may be filtered out. Any products that are recommended to the user will be currently available to purchase by the user. The product database retrieved at step 805 may be accessed to determine which products are currently available.

At step 825 the possible dialog turns, after being filtered at step 820, may be ranked. The dialog turns may be ranked based on relevance to the current conversation and/or based on a predicted optimal outcome. The dialog turns may be ranked based on an order indicated in the bot template model. The operator may have indicated a preferred order of potential next dialog turns in the bot template model. The dialog turns may be dynamically ranked, such as by the conversation optimization engine 425.

At step 830 the conversation state may be updated with the top ranked dialog turn. The highest ranked dialog turn may be selected to be output to the user. The dialog turn may comprise text to be output to the user, images, pre-filled quick-reply buttons, and/or other types of output. When the conversation state is updated, the web page or other interface being displayed to the user may be updated. For example if labels have been added to the user profile, products corresponding to those labels may be identified and updated on the web page.

At step 835 the updated conversation state may be returned. The updated conversation state may include the next dialog turn determined at step 830. The updated conversation state may include the updated user profile.

### Product Recommendation Engine

FIGS. 9A-B illustrate a flow diagram of a method 900 for determining recommended products in accordance with various embodiments of the present technology. All or portions of the method 900 may be executed by the product recommendation engine 430. In one or more aspects, the method 900 or one or more steps thereof may be performed by a computing system, such as the computing environment 100. The method 900 or one or more steps thereof may be embodied in computer-executable instructions that are stored in a computer-readable medium, such as a non-transitory mass storage device, loaded into memory and executed by a CPU. The method 900 is exemplary, and it should be understood that some steps or portions of steps in the flow diagram may be omitted and/or changed in order.

At step 905 a recommendation query may be received. For example the recommendation query may be received at step 655 of the method 600. The recommendation query may comprise a reference to a product database to search for the products to recommend. The recommendation query may comprise a user profile corresponding to the user that will be receiving the recommendations. The recommendation query may comprise an amount of items to recommend. The amount may be a minimum amount, maximum amount, and/or a range. The recommendation query may comprise an indication of a type of product to recommend, such as bundled products and/or independent lists of products. The recommendation query may comprise a list of data to be included with the recommendation, such as price, description, and/or any other type of data associated with the products. The recommendation query may comprise an identifier of a specific product or identifiers of multiple products. The recommendation query may be a request to determine whether the specified product or products are recommendable to the user or not.

At step 910 a determination may be made as to whether the recommendation is for a product bundle. The recommendation query received at step 905 may indicate whether the query is for a product bundle. If the query is for a product bundle, the method 900 may proceed to step 915. If the query is for individual products, the method 900 may proceed to step 925, described below.

At step 915 the retailer's bundle specifications may be retrieved. The bundle specifications may be retrieved from the retailer configuration database. The bundle specifications may indicate products that can be bundled together, types of products that can be bundled together, and/or other information regarding the retailer's practices for bundling products.

Each bundle specification may comprise a predicate to be satisfied to determine whether the bundle should be recommended to the user. The predicate may be intended to determine whether the bundle would be relevant to the user's expectations. The predicate may be evaluated based on the user's profile and/or the relevance of other product bundles.

Each bundle specification may comprise a list of product specifications to be included in the bundle. The specification may indicate which types of products are to be included in the bundle, and for each type of product an amount of that type of product to be included in the bundle. For example the bundle specification may indicate that a first product in the bundle should be either a bicycle or a scooter and that the second product to be included in the bundle should be a helmet. Any other types of rules may be included in the bundle specification, such as a minimum and/or maximum total number of items in the bundle, a minimum and/or maximum price of the bundle, etc.

Each bundle specification may comprise a list of product categories to be excluded from the bundle. For example products in the category “gift set” may be excluded from a bundle.

At step 920 a bundle type may be selected for recommendation to the user. One or more types of bundles may be determined based on the bundle specifications received at step 915. Each type of bundle may be associated with one or more enablement predicates indicating which types of users the bundle type should be recommended to. A bundle type to be recommended to the user may be determined based on the user profile and/or the enablement predicates.

At step 925 a list of products that are recommendable to the user may be determined. The list of products may be determined by joining each product's labels with the labels defined in the user profile. The labels stored in the user's profile may have been determined based on user input received during the conversation with the user. The list of products may be determined based on the bundle type selected at step 925. The list of products may be determined in order to satisfy a bundle specification. For example if the bundle specification selected at step 920 indicates that a novel is to be recommended to the user, at step 925 one or more novels corresponding to the user profile may be identified.

Products may be selected for the list of available products based on whether the products are available. If a product is not available, such as if the product has been discontinued or is out of stock, that product might not be included in the list of products that are recommendable. A retailer's database may be accessed to determine which products are available or not available. A local database may be maintained that is updated regularly based on the retailer's database to determine which products are available or not available. The retailer's database and/or local database may, for each product, include an indication of whether the product is available to recommend. For example each product may include an indicator of whether the product is in-stock or out-of-stock. Each product that is selected at step 925 may be checked to see if the product is available, such as by querying the retailer's database to determine whether the product is available or not. The local database may be regularly updated to indicate which products are available or unavailable. For example the local database may be compared to the retailer's database to determine whether any products have become available or unavailable.

The list of products may be determined at step 925 based on the labels in the user's profile. Filtering labels in the user's profile may be used to filter out products that should not be recommended to the user. Ranking labels may be used at step 930 to determine a ranking for the products.

At step 930 the products determined at step 925 may be ranked. The products may be ranked based on how the product labels associated with each product map to labels in the user's profile. The products may be ranked based on how far the unmapped product labels are from the labels included in the user profile. This may be measured in terms of an ontological distance. The products may be ranked based on how specific each product is with respect to the labels included in the user profile.

After ranking the products at step 930, one or more of the highest ranked products may be selected at step 935. The number of products selected may be determined based on the recommendation query received at step 905. The number of products selected may be determined based on a context for the recommendation. If the recommendation query is received for recommending products to be displayed on a web page, a relatively high number of products may be selected. If the recommendation query is received for recommending products to be recommended during a dialog, a lower number of products may be selected because more products may be displayed on a web page than during a dialog. The selected products may correspond to a specific category of products. The category may have been selected based on the user input and/or the user's profile. If a bundle is to be recommended then multiple products may be selected at step 935 based on the bundle specifications. Each product selected for the bundle may correspond to a different product category.

At step 940 data associated with the selected products may be retrieved. The types of data retrieved may be determined based on the recommendation query received at step 905. For example if the recommendation query indicated that price and description should be retrieved, then a price and a description may be retrieved for each of the products selected at step 935.

At step 945 text may be generated corresponding to each product selected at step 935. The text may indicate one or more reasons that the product is being recommended. The text may be generated based on the product labels and the corresponding user profile labels that match or don't match. The text may explain, to the user, how each product relates to the data in their user profile. For example if the user's profile indicates that they have children, and the product being recommended is approved for use by children, the text may indicate that the product is being recommended because it can be used by children.

At step 950 a determination may be made as to whether the query is for confirming if a certain product is recommendable to the user. If the query is for a product confirmation, the query may contain an identifier of a specific product or multiple identifiers of multiple products. If a product confirmation is requested, a determination may be made as to whether the product is in the list of recommendable products generated at step 925. If the given product in the query is included in the list of recommendable products, the method proceeds to step 955. At step 955 a positive result along with the generated text and/or a summary of relevant reviews is returned. Otherwise, if the product is not in the list of recommendable products, a negative answer is returned and the method continues to step 960. If, at step 950, a determination is made that the query is not for a product confirmation, the method 900 may proceed to step 960. For example, if the query does not contain any identifiers of products, the method 900 may proceed to step 960.

At step 960 the list of recommended products may be returned. The recommended products may then be output to the user along with the generated text and/or a summary of relevant reviews corresponding to the recommended products.

### Conversation Optimizer Training

A reinforcement learning algorithm may be used to select a next dialog turn during a dialog. The methods 1000 and 1100 describe an example of training a reinforcement learning MLA and using the MLA to generate predictions. The MLA may be based on a Q-learning algorithm. A typical Q-learning algorithm may be intended to operate in a consistent environment, in which a series of inputs may consistently result in a same or similar result. The dialog system 200, because it is interacting with humans, might not receive consistent results. In order to respond and adapt to an inconsistent environment, various modifications have been made to the Q-learning algorithm as described below in the steps of the methods 1000 and 1100.

FIG. 10 illustrates a flow diagram of a method 1000 for training a conversation optimizer engine in accordance with various embodiments of the present technology. All or portions of the method 1000 may be executed by the conversation optimization engine 425. In one or more aspects, the method 1000 or one or more steps thereof may be performed by a computing system, such as the computing environment 100. The method 1000 or one or more steps thereof may be embodied in computer-executable instructions that are stored in a computer-readable medium, such as a non-transitory mass storage device, loaded into memory and executed by a CPU. The method 1000 is exemplary, and it should be understood that some steps or portions of steps in the flow diagram may be omitted and/or changed in order.

At step 1005 a set of conversation records may be received. The set of conversation records may be referred to as a training data set and may be used to train an MLA. The set of conversation records may be records of conversations that were conducted between a user and the dialog system 200. The set of conversation records may correspond to one or more entities, such as a set of conversation records for an individual retailer. The set of conversation records may correspond to multiple retailers, such as if conversation records for multiple retailers are combined. A user profile corresponding to each conversation may be retrieved.

Each conversation record may comprise a list of every dialog turn that occurred during the conversation. Each conversation record may comprise a list of rewards that were achieved by the conversation. The rewards may be defined by the entity implementing the dialog system 200. The rewards may include whether a user purchased any items during and/or after the conversation, whether the user subscribed to a mailing list of the entity, etc.

The conversation optimizer engine 425 may be trained repeatedly based on newly recorded conversations. The set of conversation records received may be conversation records that were recorded since the last training of the conversation optimizer engine 425. By continuously training the conversation optimizer engine 425, the dialog system 200 may automatically adapt to changing conditions, such as user preferences changing over time.

At step 1010 a conversation record of the set of conversation records may be selected. The conversation records may be selected in any order, such as chronologically or randomly.

At step 1015 an expected reward value may be determined for the selected conversation record. The expected reward value may be predicted using an MLA. A reinforcement learning algorithm may be used to determine the expected reward value, such as a Q-learning algorithm. The expected reward value may predict the likelihood that the user in the conversation purchased a product. The expected reward value may be determined based on a state of the conversation, a next dialog turn, and/or a user profile corresponding to the conversation. The expected reward value may be determined by back propagating the total value of rewards gained through the conversation to the list of dialog turns in the conversation.

At step 1020 a statistical hypothesis test score may be determined for the conversation record. The statistical hypothesis test score may be determined based on the probability of rejecting a given next dialog turn whereas it would have been the best dialog turn to be chosen among the alternatives. The statistical hypothesis test score may be referred to as a power score. The statistical hypothesis test score may indicate an amount of differentiation between the expected reward values for each possible dialog turn.

At step 1025 a sampling confidence score for the conversation record may be determined. The sampling confidence score may be determined based on a Gaussian distribution modeling the expected number of samples to be observed for a given next dialog turn. The sampling confidence score may increase as more data displaying similar or same results is collected.

At step 1030 a minimum between the power and sampling confidence scores may be determined. The convergence rate parameter used by the reinforcement learning algorithm may be updated based on the determined minimum.

If there are more conversation records to analyze at step 1035, the method 1000 may proceed to step 1010 and a next conversation record may be selected and used to further train the MLA. Otherwise if no further conversation records remain to train the MLA, the method 1000 may end until further conversation records are received.

### Conversation Optimizer Prediction

The conversation optimizer engine 425 may be called, such as at step 645 of the method 600, to select a next dialog turn for a conversation. The conversation optimizer engine 425 may receive a set of possible dialog turns and select a next dialog turn, from the set of possible dialog turns, that is predicted to maximize the reward value.

FIG. 11 illustrates a flow diagram of a method 1100 for selecting a next dialog turn in accordance with various embodiments of the present technology. All or portions of the method 1100 may be executed by the conversation optimization engine 425. In one or more aspects, the method 1100 or one or more steps thereof may be performed by a computing system, such as the computing environment 100. The method 1100 or one or more steps thereof may be embodied in computer-executable instructions that are stored in a computer-readable medium, such as a non-transitory mass storage device, loaded into memory and executed by a CPU. The method 1100 is exemplary, and it should be understood that some steps or portions of steps in the flow diagram may be omitted and/or changed in order.

Because the dialog system 200 is operating in an inconsistent environment that changes over time, it may be beneficial to continuously test which dialog turns are most likely to result in a desired outcome. A reward value may be predicted for each possible next dialog turn. Rather than always selecting the next dialog turn with the highest reward value, the dialog system 200 may sometimes select dialog turns at random in order to determine whether the predicted reward values are consistent with actual reward values.

At step 1105 an optimization query may be received. The optimization query may be a request to select a next dialog turn for a conversation. The optimization query may comprise a conversation state of the conversation. The conversation state may include a sequence of all the dialog turns that were previously exchanged with the user during the conversation. The optimization query may comprise a set of possible next dialog turns that can be employed during the conversation. The conversation state may comprise a profile of the user engaged in the conversation.

At step 1110 a predicted reward value may be determined for each possible dialog turn. The predicted reward value may be determined by inputting the possible dialog turn to an MLA, such as the reinforcement learning algorithm trained using the method 1000. A power confidence and/or sampling confidence may be determined for each possible dialog turn and predicted reward. The sampling confidence may be determined for each dialog turn having multiple possible next dialog turns.

At step 1115 a determination may be made as to whether a next dialog turn should be selected based on the predicted reward value or at random. To reduce bias in the dialog system 200, in some instances dialog turns will be selected at random rather than based on the predicted reward values. This will ensure that the dialog system 200 tests out different possible dialog turns and receives measured results regarding the effectiveness of those dialog turns.

The effectiveness of dialog turns may change over time. The predicted reward value for a dialog turn may be relatively low because that dialog turn was not effective in the past, but due to changes in conditions that dialog turn might now be more effective. By randomly selecting the dialog turn, the dialog system 200 will re-test the effectiveness of that dialog turn even though it has a low predicted reward value.

To determine whether to select the dialog turn randomly, a random number between 0 and 1 may be determined. The random number may be compared to the sampling confidence determined at step 1110. If the random number is greater than the sampling confidence, then a next dialog turn may be selected completely at random at step 1120. If the random number is less than the sampling confidence, then the method 1100 may continue to step 1125.

If, at step 1115, a determination is made to select the dialog turn at random, then at step 1120 a dialog turn from the set of possible next dialog turns may be selected at random and then returned at step 1145.

If the determination at step 1115 is to not select the dialog turn at random, then at step 1125 a determination may be made as to whether the dialog turn having the highest predicted reward value should be selected. As the power score and confidence scores increase, it may be beneficial to take advantage of the previous learnings and reduce the frequency at which random dialog turns are selected. Thompson sampling, or any other method, may be used to determine the next dialog turn.

The random number determined at step 1115 may be compared to the sampling confidence and power confidence. If the random number is below both the sampling confidence and the power confidence, then the dialog turn with the highest predicted reward value may be selected at step 1140. Otherwise, if the random number is between the sampling confidence and the power confidence, then the method 1100 may continue to step 1130.

At step 1130 the possible dialog turns may be filtered based on predicted reward values. Various techniques may be used to filter the possible dialog turns. A predetermined number or percentage of dialog turns having a lowest predicted reward value may be filtered out. Dialog turns having a predicted reward value below a threshold reward value may be filtered out.

After filtering out the possible dialog turns at step 1130, at step 1135 a dialog turn may be selected at random from the remaining dialog turns. By selecting the dialog turn randomly, rather than simply selecting the dialog turn with the highest predicted reward value, the dialog system 200 may ensure that the conversation will not get locked into a single dialog path. This will also ensure that the dialog system 200 can dynamically adapt to changing conditions, by continuously re-testing the actual reward value of various dialog turns and comparing the measured reward value to the predicted reward value. The randomly selected dialog turn may be returned at step 1145.

At step 1140 the dialog turn having the highest predicted reward value may be selected as the next dialog turn. After selecting the next dialog turn, at step 1145 the dialog turn may be returned.

### Personalized Reviews Pre-Processing

FIG. 12 illustrates a flow diagram of a method 1200 for pre-processing personalized reviews in accordance with various embodiments of the present technology. All or portions of the method 1200 may be executed by the personalized reviews engine 415. In one or more aspects, the method 1200 or one or more steps thereof may be performed by a computing system, such as the computing environment 100. The method 1200 or one or more steps thereof may be embodied in computer-executable instructions that are stored in a computer-readable medium, such as a non-transitory mass storage device, loaded into memory and executed by a CPU. The method 1200 is exemplary, and it should be understood that some steps or portions of steps in the flow diagram may be omitted and/or changed in order.

The method 1200 may be used to pre-process reviews so that they can be used by the dialog system 200 during a dialog with a user. The reviews may be parsed so that all or portions of the reviews can be returned during a dialog.

At step 1205 a set of reviews may be retrieved. The set of reviews may be a set of reviews for a single entity, such as a retailer. The reviews may be reviews submitted by customers. Each review may be associated with an item sold by the retailer. As additional reviews become available, the method 1200 may be executed again to pre-process those additional reviews.

At step 1210 a review in the set of reviews may be selected. The reviews may be selected in any order, such as in chronological order or a random order.

At step 1215 labels may be extracted from the review. The text may be parsed to extract the labels. Each label may comprise one or more words. The labels may map the review to concepts defined in a domain ontology. The labels may have been automatically identified and/or manually entered by an operator.

At step 1220 a rating may be extracted from the review. The rating may be a star rating, a numerical rating, a binary rating such as thumbs up or thumbs down, and/or any other type of rating.

At step 1225 a sentiment score may be determined based on the rating extracted at step 1220. The sentiment score may be a normalized value determined based on the rating. The sentiment scores may have a predetermined range.

At step 1230 parsed trees of sub-phrases may be generated. For each sentence in the review, a parsed tree of sub-phrases may be extracted. A constituency parser algorithm may be used to extract the parsed tree. The constituency parser algorithm may receive the sentence and return the parsed tree. The text of the sentence may be stored in leaf nodes of the tree. Each branch connecting to a leaf node may indicate the type of text stored on the leaf node, such as a verb, noun, etc.

At step 1235 the parsed trees for the review may be stored. Each parsed tree may be associated with one or more labels and/or one or more sentiment scores. The parsed trees for the review may be associated with each of the labels for the review. The parsed trees for the review may be associated with the sentiment score determined at step 1225.

At step 1240 a determination may be made as to whether there are any additional reviews to pre-process. If there are no remaining reviews to pre-process, the method 1200 may end. If there are additional reviews, then a next review in the set of reviews may be selected at step 1210.

### Personalized Reviews During Chat

During a conversation, the dialog system 200 may generate and/or output a review summary to the user. For example at step 665 of the method 600 a summary of relevant review may be generated. By providing relevant reviews to the user, the user may be more likely to purchase a product.

FIGS. 13A-13B illustrates a flow diagram of a method 1300 for generating review summaries in accordance with various embodiments of the present technology. All or portions of the method 1300 may be executed by the personalized reviews engine 415. In one or more aspects, the method 1300 or one or more steps thereof may be performed by a computing system, such as the computing environment 100. The method 1300 or one or more steps thereof may be embodied in computer-executable instructions that are stored in a computer-readable medium, such as a non-transitory mass storage device, loaded into memory and executed by a CPU. The method 1300 is exemplary, and it should be understood that some steps or portions of steps in the flow diagram may be omitted and/or changed in order.

At step 1305 a personalized review query may be received. The personalized review query may be a request for a generated summary of reviews for one or more products. The personalized review query may comprise an indication of one or more products that the reviews are requested for. The personalized review query may comprise a user profile of the user engaged in a conversation with the dialog system 200. The personalized review query may contain a sentiment value, such as positive, neutral, or negative. The sentiment value may indicate the type of reviews to be returned. The personalized review query may comprise a maximum number of characters and/or sentences to be included in the summary. The personalized review query may comprise a number of reviews to be summarized. The number of reviews to be summarized may be a maximum amount, minimum amount, range, and/or exact number.

At step 1310 reviews corresponding to the product or products specified in the personalized review query may be retrieved. A query may be used to retrieve all reviews corresponding to the product or products. The labels, sentiment value, and/or parsed trees corresponding to each review may be retrieved.

At step 1315 the retrieved reviews may be filtered based on the sentiment value specified in the personalized review query. The sentiment value received in the personalized review query may correspond to a range of sentiment values. Reviews having sentiment values that fall outside of that range may be filtered out.

At step 1320 the reviews may be ranked based on the number of labels associated with each review that map to the user profile of the user engaged in the conversation. For each review, the number of labels associated with the review that match a label in the user profile may be determined. The reviews may then be ranked based on the number of matching labels.

After ranking the reviews, the reviews may be filtered based on their rankings. The reviews having the lowest number of matching labels may be filtered out. A predetermined number of lowest-ranked reviews may be filtered out based on their ranking. A predetermined number of highest-ranked reviews may be selected to remain.

At step 1325 a longest adjective or verb phrase having less than the maximum number of characters indicated in the personalized review query may be determined for each sentence of each review. The parse trees may be retrieved for each of the remaining reviews after the filtering performed at step 1320. The parse trees may indicate, for each leaf node, the type of text contained in the leaf node. The longest adjective or verb phrases stored in the leaf nodes that have less than the maximum number of characters may be retrieved. A tree search algorithm may be used to search the trees and select the longest phrases having less than the specified number of characters.

At step 1330, for each adjective or verb phrase selected at step 1325, a sentence modelled by the selected parse tree may be generated. The adjective or verb phrases for each parse tree may be sub-phrases of the sentence modelled by the parse tree. In other words, for each review, portions of the sentences of the review may be extracted.

At step 1335 the generated sentences may be regrouped. Each of the sub-phrases extracted at step 1330 may be formed into sentences.

At step 1340 each of the generated sentences may be ranked based on how opinionated the generated sentence is. The generated sentences may be compared to a list of keywords, where each keyword in the list is associated with an opinion score. Based on the list, an opinion score may be determined for each of the generated sentences and the generated sentences may be ranked. The generated sentences may be input to an MLA that outputs a predicted opinion score. The generated sentences may be ranked based on the output of the MLA.

At step 1345 the generated sentences having the highest opinion scores may be selected. The generated sentences having the highest opinion scores may be the most opinionated sentences that were generated based on the reviews. A predetermined number of generated sentences may be selected.

At step 1350 the sentences may be regrouped per review. At step 1355 the generated list of review summaries may be returned.

### Conversational Language Understanding Engine

The conversational language understanding engine 420 may be used to predict intent and/or entities mentioned in text input received from a user during a conversation. The conversational language understanding engine 420 may be called at step 620 of the method 600 to process a text input that was received. After receiving a text input, the conversational language understanding engine 420 may output a predict intent and/or a list of predicted entities corresponding to the text input.

FIG. 14 illustrates a flow diagram of a method 1400 for determining a predicted intent in accordance with various embodiments of the present technology. All or portions of the method 1300 may be executed by the conversational language understanding engine 420. In one or more aspects, the method 1400 or one or more steps thereof may be performed by a computing system, such as the computing environment 100. The method 1400 or one or more steps thereof may be embodied in computer-executable instructions that are stored in a computer-readable medium, such as a non-transitory mass storage device, loaded into memory and executed by a CPU. The method 1400 is exemplary, and it should be understood that some steps or portions of steps in the flow diagram may be omitted and/or changed in order.

At step 1405 a language understanding query may be received. The language understanding query may comprise the current conversation state. The current conversation state may include the sequence of all dialog turns which have been exchanged with the user and the most recent text input received from the user.

At step 1410 the most recent text input received from the user may be pre-processed to generate one or more tuples. The text input may be split into multiple tuples, where each tuple represents a word in the text input. Each tuple may comprise a token and a lemma corresponding to the token. The token may comprise one or more words in the text input. The lemma may be a base word corresponding to the token. For example the token may be the word “am,” “is,” “are,” “was,” or “were.” In this example, the associated lemma would be the word “be”. The lemma may be the linguistic root of the word in the token.

At step 1415 the entities mentioned in the most recent text input may be predicted. The entities may be predicted using an MLA that receives text as input and outputs entities corresponding to the text.

At step 1420 the most recent text input may be anonymized. Entity words in the text input may be replaced by entity types to reduce the sparsity of the data. A dictionary may be maintained comprising words and, for each word, an associated entity type. When a word in the dictionary is detected in the text input, the word may be replaced by the associated entity type.

At step 1425 feature vectors may be extracted based on pre-trained word embeddings.

At step 1430 the intent of the most recent text input may be predicted using a first model. The model may be a bag words model using a Bayesian attention model discriminating focus words locally within the last message and globally within the context of the dialog.

At step 1435 the intent of the most recent input may be predicted using a second model. The second model may be a conversational attention model that applies recurrent deep learning to the latest message within the context of the previous dialog turns.

At step 1440 the predicted intents output by the two models may be merged. A hybrid confidence classifier may be used to determine the best prediction based on the outputs of the two models.

At step 1445 the predicted intent determined at step 1440 may be output and/or the list of predicted entities determined at step 1415 may be output.

### Training a Model for Variant Selection

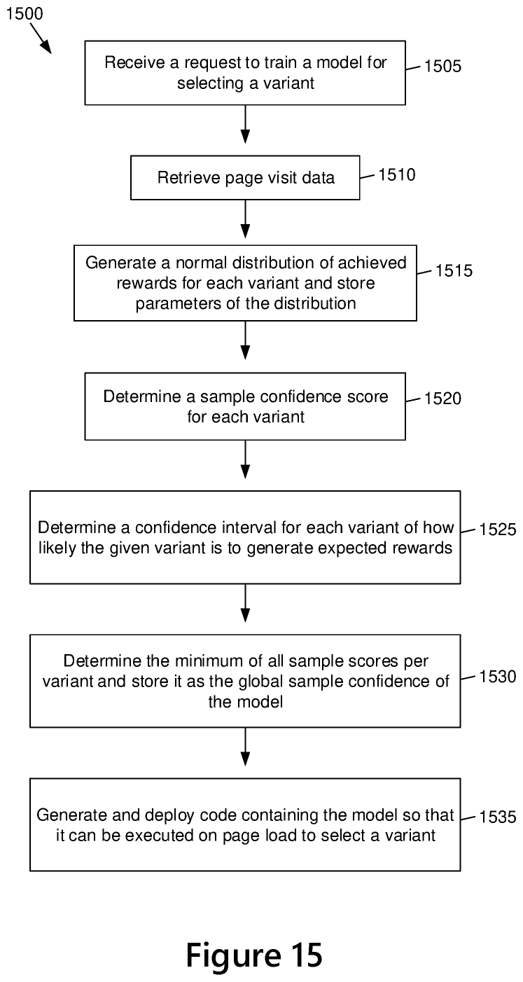

FIG. 15 illustrates a flow diagram of a method 1500 for training a model for selecting a variant in accordance with various embodiments of the present technology. All or portions of the method 1500 may be executed by the web optimizer 445. In one or more aspects, the method 1500 or one or more steps thereof may be performed by a computing system, such as the computing environment 100. The method 1500 or one or more steps thereof may be embodied in computer-executable instructions that are stored in a computer-readable medium, such as a non-transitory mass storage device, loaded into memory and executed by a CPU. The method 1500 is exemplary, and it should be understood that some steps or portions of steps in the flow diagram may be omitted and/or changed in order.

At step 1505 a request to train a model for selecting a variant may be received. The model may be trained to select a variant of a web page and/or select a variant of an element of a web page. The model may be trained at a regular interval which may be pre-determined, such as daily. The model may be trained after a threshold amount of new information has been received, such as after the web page has been displayed a predetermined amount of times.

The model may be trained to select a variant for display that will maximize a target reward. The target reward may be a user-defined reward. For example the target reward may be a selection of an element of the web page, purchase of an item, amount of time that a user spends browsing the web page, and/or any other reward. The target reward may indicate a single action to be completed to achieve the reward or may indicate multiple actions that could each satisfy the reward. For example the target reward may be defined so that it is achieved when a user adds an item to their cart and/or when the user adds the item to their wish list.

At step 1510 page visit data corresponding to the web page may be retrieved. The page visit data may indicate, for each page load, which variant was selected and whether the target reward was achieved. When a new training request is received at step 1505, the exhaustive list of page load records may be retrieved. The page visit data may be retrieved from a database.

At step 1515 a normal distribution of achieved rewards may be generated for each variant. For each variant, a normal distribution to model the likelihood of achieving the target reward may be generated using the page visit data. The parameters of the normal distribution may then be stored in association with the respective variant. The mean and/or standard deviation of the distribution may be stored for each variant.

At step 1520 a sample confidence score may be determined for each variant. The sample confidence score may be determined based on a Gaussian distribution modelling the expected number of samples to be observed. The sample confidence score may increase as more data displaying similar or same results is collected. The sample confidence score may be stored for each variant.

At step 1525 a confidence interval may be determined for each variant. The confidence interval may indicate how likely the respective variant is to achieve the target reward. The confidence interval may be adjusted based on the number of samples that have been collected so far based on the normal distribution and the sample confidence for the respective variant. The confidence interval of a variant may be considered a power score of the respective variant because it is a statistical hypothesis test score that may indicate an amount of differentiation between the likelihood of achieving the target rewards between different variants. The confidence interval may be stored for each variant.

At step 1530 a global sample confidence score of the model may be determined. The sample confidence scores determined at step 1520 for each variant may be compared. The lowest sample confidence score may be selected as the global sample confidence score of the model.

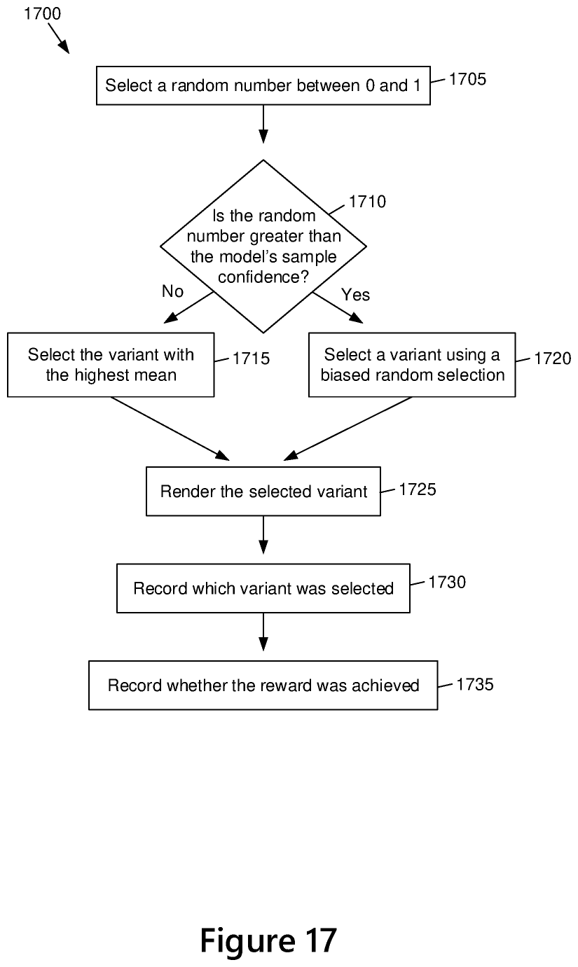

At step 1535 code containing the model may be generated and deployed. The code, when executed, may select a variant to render. FIG. 17, described below, describes a method that may be executed by the code for selecting a variant. The code may be JavaScript and/or any other type of code. The code may be executed by a user's browser when the user requests the web page containing the code.

The parameters determined in steps 1515 to 1530 may be used to generate a JavaScript library which will execute the model at runtime when the page loads to optimize the user experience. Rather than having the parameters of the model retrieved through a server call, the code containing the parameters may be executed independently in the user's browser with the specific model parameters. This may decrease the amount of time used for rendering the web page. The code may be executed by a web browser, mobile application, and/or any other type of application.

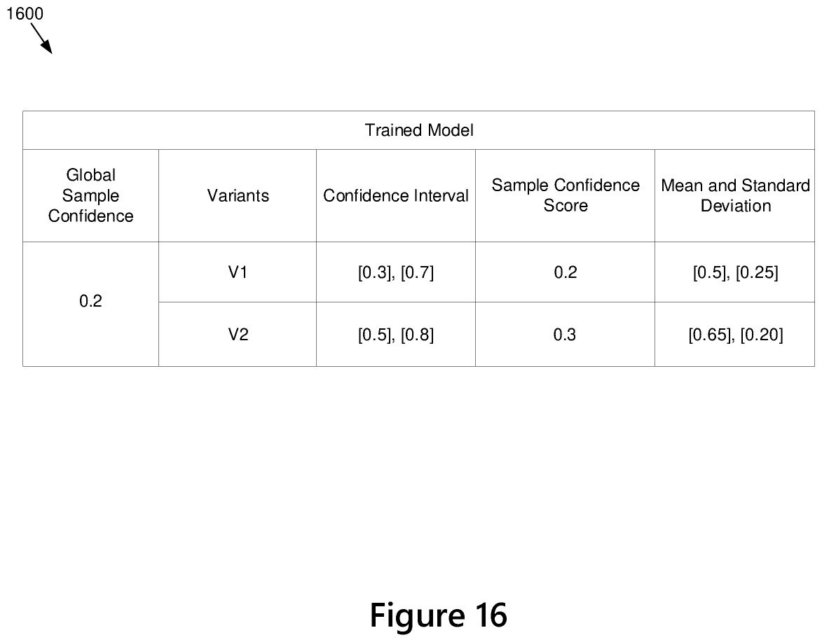

FIG. 16 illustrates data stored in a trained model for selecting a variant in accordance with various embodiments of the present technology. The trained model 1600 comprises data for multiple variants. In the trained model 1600 there are two variants, V1 and V2, but any number of variants may be included in the trained model 1600. For each variant there is an associated sample confidence score and confidence interval. The sample confidence score for each variant may have been determined at step 1520 of the method 1500. The confidence interval may have been determined at step 1525 of the method 1500. The confidence interval may indicate how likely the respective variant is to achieve the target reward.

The trained model 1600 may comprise parameters of a distribution corresponding to each variant, such as a mean of the variant's distribution, standard deviation of the distribution, and/or any other parameters of the distribution. The parameters of each variant's distribution may have been determined at step 1515 of the method 1500. The trained model 1600 may comprise a global sample confidence. The global sample confidence may be the lowest of the variant's sample confidence scores. The global sample confidence may have been determined at step 1530 of the method 1500.

### Selecting a Variant to be Rendered

FIG. 17 illustrates a flow diagram of a method 1700 for selecting a variant in accordance with various embodiments of the present technology. All or portions of the method 1700 may be executed by code generated by the web optimizer 445. In one or more aspects, the method 1700 or one or more steps thereof may be performed by a computing system, such as the computing environment 100. The method 1700 or one or more steps thereof may be embodied in computer-executable instructions that are stored in a computer-readable medium, such as a non-transitory mass storage device, loaded into memory and executed by a CPU. The method 1700 is exemplary, and it should be understood that some steps or portions of steps in the flow diagram may be omitted and/or changed in order.

When a user opens a web page which has multiple possible variants, the user's browser may execute a JavaScript library that includes instructions for selecting a variant, such as code generated using the method 1500 described above. This code may contain specific model parameters that will optimize the user experience.

At step 1705 a random number may be selected between 0 and 1. The random number may be generated based on a uniform distribution. Although the method 1700 describes using a random number between 0 and 1, it should be understood that any range of numbers may be used and the steps of the method 1700 be adjusted accordingly.

At step 1710 the random number may be compared to the global sample confidence score of the model. The global sample confidence score of the model may have been determined at step 1530 of the method 1500. The global sample confidence score may be stored in the code generated by the method 1500. The possible values of the global sample confidence score may range from 0 to 1.

If the random number is less than or equal to the global sample confidence score, then the learnings of the model may be exploited and the variant having the highest mean of the computed normal distribution may be selected to be rendered at step 1715. The selected variant may be the most likely variant to achieve the target reward of the model. As the global sample confidence score grows over time, the likelihood that the variant most likely to achieve the target reward will be selected also grows accordingly.

On the other hand, if the random number is greater than the model's global sample confidence score, then a variant may be selected on a random basis at step 1720. A biased random number generator may be used to select which variant will be selected. The bias may be based on the confidence interval (i.e. power score) of each variant, in such a way as to favor the variants with higher confidence intervals. In other words variants that are more likely to achieve the target reward will be more likely to be selected. Alternatively, the selection may be a random selection in which each variant has an equal chance of being selected.

At step 1725 the variant selected at either step 1715 or 1720 may be rendered. The user experience corresponding to the selected variant may be rendered by the user's browser. The variant may be a web page, a configurable element of a web page, or any other element of the user experience.

At step 1730 a record of which variant was selected at step 1715 or 1720 may be stored. The record may indicate which variant was rendered. After the rendering is completed, the browser may send a log message to a server indicating the variant that was selected. The log message may be sent to the server that sent the web page. The log message may be sent to an address stored in the code.

At step 1735 a determination may be made as to whether the target reward was achieved. If the user behaves in such a way to achieve the target reward an additional message may be sent to the server indicating that the target reward was achieved. For example if the target reward is to engage in a conversation and the user engages in the conversation, an indication that the user engaged in the conversation may be transmitted. Additional information may be transmitted regarding the user's behavior, such as information regarding any other activities the user engaged in while browsing the web page. The data collected at steps 1730 and 1735 may be used as new training data for further training the model and generating an updated model using the method 1500. This new training data is generated based on real usage and may be used the next time the training is executed.

### Product Labelling

Products in a database, such as the products a retailer is offering for sale on their e-commerce platform, may be labelled with various labels describing the product. Each product in the database may include text associated with that product, such as a description of the product, reviews of the product, and/or any other text associated with the product. Labels may be assigned to the product and/or words in the text associated with the product. These labels may be assigned manually by a human operator and/or automatically by a trained model.

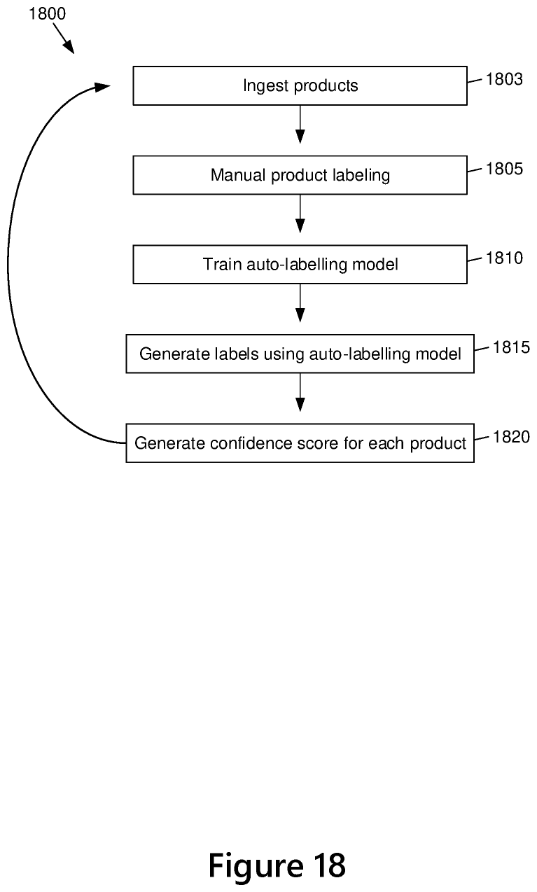

FIG. 18 illustrates a flow diagram of a method 1800 for labelling products using manual and automatic labelling in accordance with various embodiments of the present technology. All or portions of the method 1800 may be executed by the product labeler 510. In one or more aspects, the method 1800 or one or more steps thereof may be performed by a computing system, such as the computing environment 100. The method 1800 or one or more steps thereof may be embodied in computer-executable instructions that are stored in a computer-readable medium, such as a non-transitory mass storage device, loaded into memory and executed by a CPU. The method 1800 is exemplary, and it should be understood that some steps or portions of steps in the flow diagram may be omitted and/or changed in order.

At step 1803 products may be ingested from the database. A local database may be updated to contain the products from the database. The products in the local database may be labelled using the steps described below. Any text associated with the products may be ingested from the database. If products have previously been ingested from the database, any changes to the products in the database may be determined. Products that have been added to the database may be ingested, products that have been removed from the database may be removed from the set of products labelled using the method 1800, and/or any changes to the products in the database may be ingested.

At step 1805 products may be labelled manually. A human operator may review the text associated with products and manually apply labels. The labels may be predefined and/or entered by the operator. The labels may be selected from an ontology of labels. The ontology may contain labels in a hierarchical format. For example the operator may select the word “blue” in the text associated with the product, and then select a root label “color” and a child label “blue.” If the operator enters a label that is not in the ontology, the label may be added to the ontology. The parent labels of a child label may automatically be selected when the child label is selected. For example if the operator selects the word “blue” in the text associated with the product and then selects the label “blue” for that word, the root label “color” may also be selected automatically and assigned without further user input.

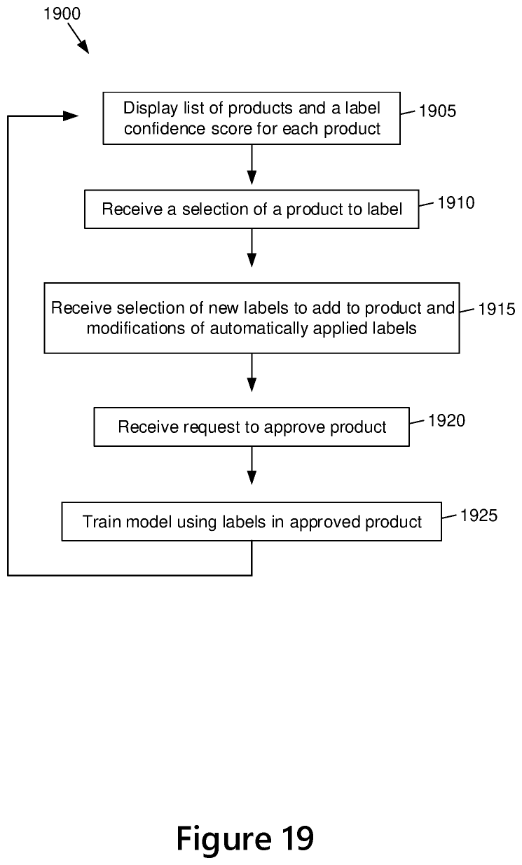

The products may have been previously labelled, such as using an auto-labelling model or other type of model. If the products have already been labelled, at step 1805 the operator may review the labels that were automatically applied. The operator may add, remove, and/or edit the labels that were automatically applied. Each product and/or individual label may include an associated confidence score. The operator may select to review products and/or labels having relatively lower confidence scores. If a product and/or an individual label has a relatively high confidence score, the operator might not select to review that label or that product. The method 1900, described below and in FIG. 19, describes actions for labelling products that may be performed at step 1805.

At step 1810 an auto-labelling model may be trained. The auto-labelling model may be trained based on the labels that were manually input at step 1805. The auto-labelling model may be retrained at various intervals, such as after each product has been approved by the operator, after a set number of products have been approved by the operator, at a pre-determined time interval, after a whole database of products have been approved by the operator, and/or at any other interval. The method 2000, described below and in FIGS. 20A and 20B, describes actions for training a model that may be performed at step 1810.

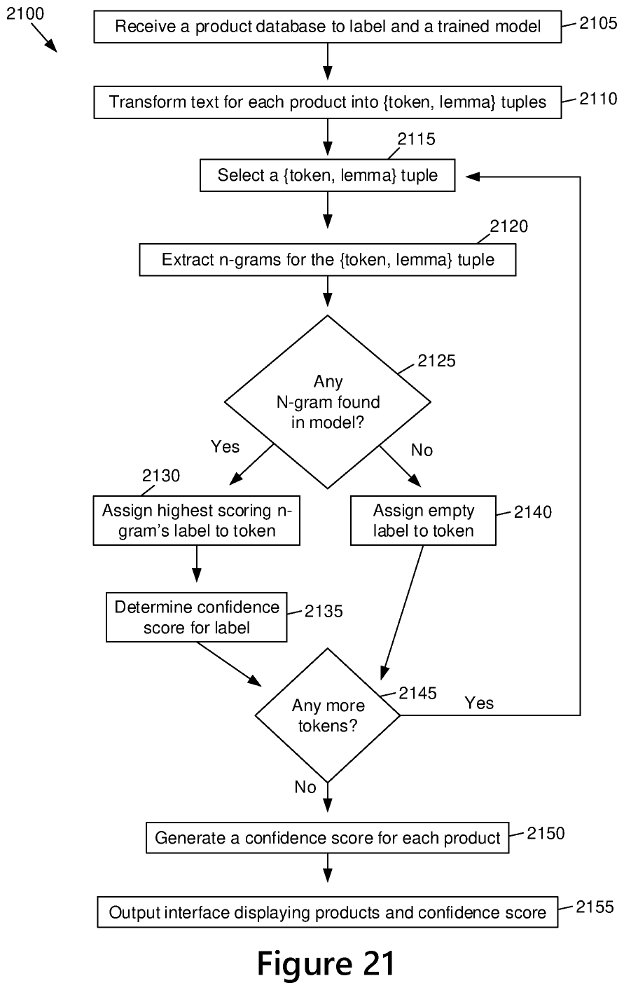

At step 1815 labels may be generated using the auto-labelling model trained at step 1810. The database of products may be input to the auto-labelling model. The auto-labelling model may analyze each product and the text associated with each product to determine labels to apply to the product. The auto-labelling model may output a confidence score associated with each label. The method 2100, described below and in FIG. 21, describes actions for generating labels that may be performed at step 1815.

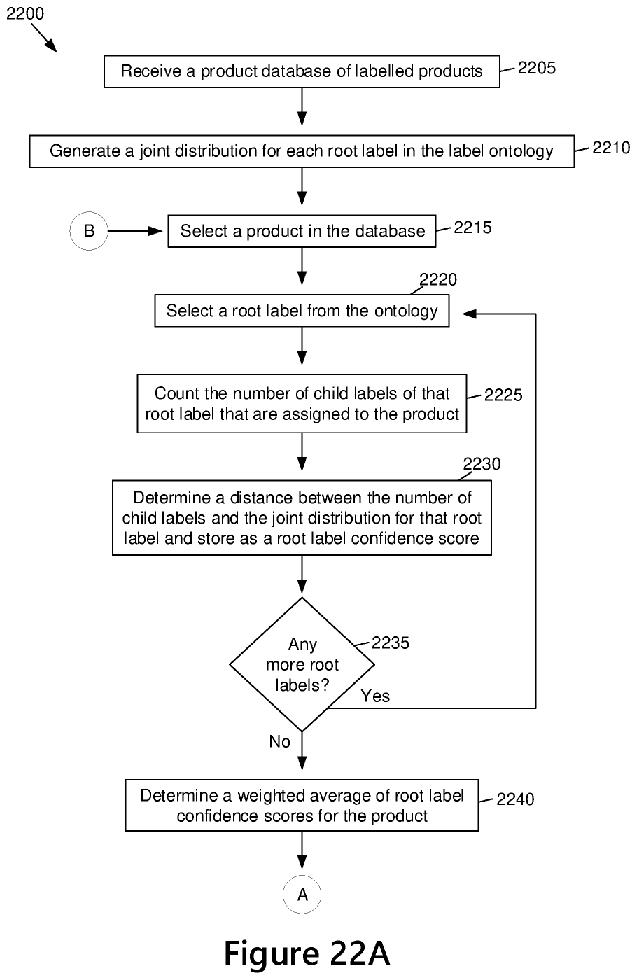

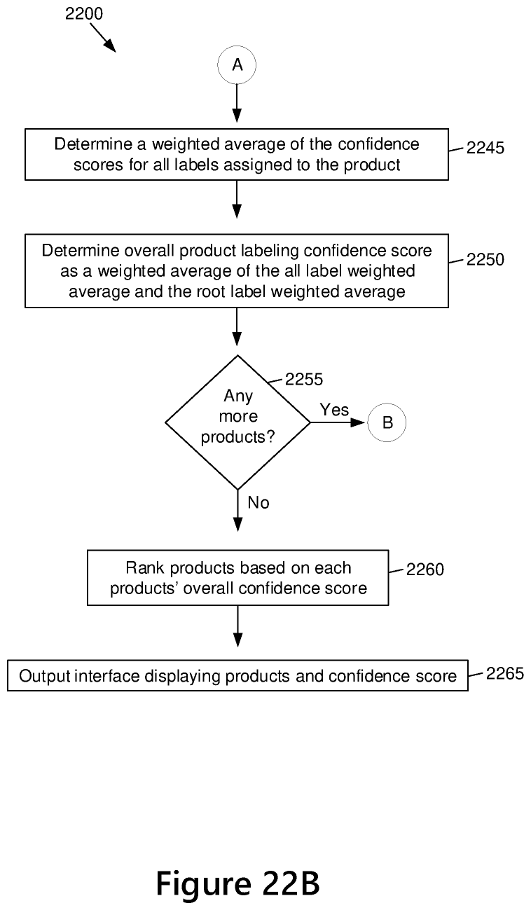

At step 1820 a confidence score may be generated for each product. The confidence score may be used by a human operator to select which products to review. The method 2200, described below and in FIGS. 22A and 22B, describes actions that may be performed at step 1820 for generating a confidence score for a product. After generating a confidence score for each product, the method 1800 may continue at step 1803 where any changes to the products may be detected and/or new products may be ingested.

FIG. 19 illustrates a flow diagram 1900 of a method for manually labelling products in accordance with various embodiments of the present technology. All or portions of the method 1900 may be executed by the product labeler 510. In one or more aspects, the method 1900 or one or more steps thereof may be performed by a computing system, such as the computing environment 100. The method 1900 or one or more steps thereof may be embodied in computer-executable instructions that are stored in a computer-readable medium, such as a non-transitory mass storage device, loaded into memory and executed by a CPU. The method 1900 is exemplary, and it should be understood that some steps or portions of steps in the flow diagram may be omitted and/or changed in order.

At step 1905 a list of products may be displayed. The list of products may be products in a database, such as a retailer's database of products. For each product a product name, product image, product identification number, and/or any other information regarding the product may be displayed. Each product may be displayed with a confidence score corresponding to the product. The confidence score may indicate a confidence in labels that were assigned to a product. The products may be ordered based on the associated confidence score. For example products with lower confidence scores may be displayed first on the list.

At step 1910 a selection of a product may be received. The selection may be made by an operator accessing a user interface displayed at step 1905. The operator may select a product to apply labels to the product, review labels applied to the product, and/or edit labels applied to the product. The operator may select the product based on the confidence score associated with the product.

At step 1915 input may be received indicating that labels should be added to the product, removed from the product, and/or edited. The operator may select a word or words in text associated with the product to apply a label to that word or words. The operator may then select a label or labels to apply to the selected word or words. The operator may add additional labels to the product. The operator may remove labels that were automatically applied to the product. The operator may edit labels that were automatically applied to the product. The operator may select labels that are pre-defined, such as labels that have previously been input for products. The operator may type in a new label that has not previously been defined.

At step 1920 a request to approve the product may be received. After the operator has finished adding, removing, and/or editing labels at step 1915, the operator may request to approve the labels at step 1920.

At step 1925 an auto-labelling model may be trained based on the products that have been approved by the operator. All of the approved products may be used to train the auto-labelling model. The method 2000, described below and in FIGS. 20A and 20B, describes actions for training a model that may be performed at step 1925. The auto-labelling model may be trained after each product is approved, after a pre-determined number of products have been approved, after the operator requests for the model to be trained, after a pre-determined amount of time, and/or at any other interval.

After the auto-labelling model has been trained, a set of labels may be generated for each product that has not been approved using the auto-labelling model. The products, labels, and/or a confidence score for each product may then be displayed at step 1905. In this manner, an operator may be able to continuously improve the accuracy of the auto-labelling model by selecting products with a low confidence score, adjusting the labels for those products, approving the labelled products after manually adjusting the labels, and then re-training the auto-labelling model using those newly approved products.

FIGS. 20A and 20B illustrate a flow diagram 2000 of a method for generating a model for labelling products in accordance with various embodiments of the present technology. All or portions of the method 2000 may be executed by the product labeler 510. In one or more aspects, the method 2000 or one or more steps thereof may be performed by a computing system, such as the computing environment 100. The method 2000 or one or more steps thereof may be embodied in computer-executable instructions that are stored in a computer-readable medium, such as a non-transitory mass storage device, loaded into memory and executed by a CPU. The method 2000 is exemplary, and it should be understood that some steps or portions of steps in the flow diagram may be omitted and/or changed in order.

At step 2005 a request may be received to train an auto-labelling model. The request may include a reference to a database of products, such as an address of the database and/or instructions for accessing the database.

At step 2010 the product database may be retrieved. The product database may include a set of products, product images, product reviews, descriptions of products, and/or any other information pertaining to the products. The product database may include labels for some or all of the products. The labels may have been manually input and/or automatically generated. Each product may include an indication as to whether the labels for that product have been approved by an operator. Although described as a database, it should be understood that product information may be stored and/or retrieved in any suitable format.

At step 2015 a product from the database may be selected. The product may be a product that was approved by an operator. In other words a human operator may have reviewed, edited, and/or approved the labels for the selected product. Any product in the database that was approved by an operator may be selected.

At step 2020 text associated with the selected product may be converted to {token, lemma} tuples. The text associated with the product may include a description of the product, product reviews, and/or any other text related to the product. A {token, lemma} tuple may be generated for each word in the text. The token may be the word in the text. For example if the product descriptions says “widescreen television with surround sound,” a tuple may be generated for each of these tokens: ‘widescreen’, ‘television’, ‘with’, surround’, ‘sound’. To form the tuple, a lemma may be determined for each token. The lemma for a word can be determined using rules, dictionaries, and/or any other type of lemmatizer. The method of determining the lemma for a tuple may be selected based on the language of the text. For example if the language of the text is French, a dictionary may be used for determining the lemma corresponding to a token.

At step 2025 n-grams may be extracted for each of the {token, lemma} tuples. Each n-gram may contain the token and a set number of words surrounding the token. For example a 3-gram may contain the token, the word preceding the token, and the word following the token. In another example a 3-gram may include the token and the next two words following the token. The set of n-grams that are extracted for each token may be predetermined and/or determined dynamically. For example n-grams having a greater number of words may continue to be extracted until an n-gram satisfying a threshold confidence level is extracted.

At step 2030 a counter may be incremented for each of the extracted n-grams. The counter may indicate the number of times that a label assigned to the token associated with the n-gram has been assigned to the n-gram. For each n-gram a set of counters may be stored indicating each label that has been assigned to the n-gram, and for each label, the amount of times that the label has been assigned to the n-gram. If a label was not assigned to the token corresponding to an n-gram, a counter may be incremented for that n-gram indicating the number of times that the n-gram was not labelled.

At step 2035 a determination may be made as to whether there are any additional labelled products that have been approved by an operator left to process in the database. If so, the method 2000 may proceed to step 2015 where a next product may be selected. Otherwise, if all labelled products have already been selected at step 2015, the method 2000 may proceed to step 2040.

At step 2040 the counters for all of the n-grams may be normalized. A likelihood score for each n-gram context to be assigned to a given label may be determined. For example if the 2-gram ‘blue pants’ has been assigned the label ‘blue’ three times and ‘empty’ once, the likelihood score for that 2-gram will be 0.75 that the 2-gram is assigned the label blue and 0.25 that the 2-gram is not assigned a label (empty).

At step 2045 a sampling confidence score for each n-gram may be determined. The sampling confidence score may be determined based on a Gaussian distribution modelling the expected number of samples to be observed. The sampling confidence score may increase as a given n-gram is encountered more in the training data. The sampling confidence score for an n-gram may be determined based on the counts for that n-gram.

At step 2050 a confidence score may be determined for each paired n-gram and label. The confidence score for an n-gram may be determined based on the likelihood of the n-gram to label assignment as determined at step 2040 and/or based on the sample confidence score for the n-gram as determined at step 2045. The confidence score may be whichever is lower, either the likelihood determined at step 2040 or the sample confidence score determined at step 2045.

At step 2055 the generated model may be stored. The generated model may include the set of extracted n-grams, the likelihood scores for each n-gram generated at step 2040, and/or the sampling confidence score for each n-gram determined at step 2045.

FIG. 21 illustrates a flow diagram of a method 2100 for automatically labelling products in accordance with various embodiments of the present technology. All or portions of the method 2100 may be executed by the product labeler 510. In one or more aspects, the method 2100 or one or more steps thereof may be performed by a computing system, such as the computing environment 100. The method 2100 or one or more steps thereof may be embodied in computer-executable instructions that are stored in a computer-readable medium, such as a non-transitory mass storage device, loaded into memory and executed by a CPU. The method 2100 is exemplary, and it should be understood that some steps or portions of steps in the flow diagram may be omitted and/or changed in order.

At step 2105 a product database to be labeled and a trained model may be received. The trained model may have been generated using the method 2000, described above and in FIGS. 20A and 20B. The product database may include a set of products, one or more images of each product, text associated with the products, and/or any other information regarding the products. Although described as a database, product information may be received in any suitable format at step 2105. If the product database has previously been labelled, any products that have been changed in the database and/or new products may be retrieved at step 2105. Rather than re-labelling the entire product database, labels may be determined for the new products and/or products that have been modified.

At step 2110 the text associated with each product may be transformed into {token, lemma} tuples. Similar to the actions described with regard to step 2020, each word may be extracted from the text and used as a token. For each token, a lemma may be determined such as by using rules and/or a dictionary to determine the lemma.

At step 2115 a {token, lemma} tuple may be selected from the set of tuples generated at step 2110. A token may be selected, a lemma may be selected, and/or a {token, lemma} tuple may be selected. The {token, lemma} tuples may be selected in any order.

At step 2120 n-grams may be extracted for the tuple selected at step 2115. Actions similar to those described with regard to step 2025 may be performed for extracting the n-grams. The amount of n-grams to be extracted may be predetermined and/or determined dynamically. For each {token, lemma} tuple, any number of n-grams containing the token may be extracted.

At step 2125 a determination may be made as to whether any of the extracted n-grams are found in the trained model. If any of the n-grams was encountered during the training of the model, those n-grams may be found in the trained model. Otherwise, if none of the n-grams extracted at step 2120 were encountered during training, the n-grams might not be found in the trained model.

If any of the n-grams were found in the model at step 2125, the method 2100 may proceed to step 2130. At step 2130, the highest-scoring n-gram's label may be applied to the token. A highest-scoring label and corresponding score may be determined for each of the n-grams using the trained model. For example if the text to be labelled includes the text “this red shirt goes well with a blue pant,” the token “blue” may have the following n-grams: “blue” which maps to label “BLUE” with 0.4 likelihood, “blue pant” which maps to label “BLUE” with 0.5 likelihood, “with blue” which maps to label “0” with 0.4 likelihood, “well with blue” which maps to label “0” with 0.5 likelihood, and “goes well with blue” which maps to label “0” with 0.7 likelihood. In this example the label “0” is a dummy label that indicates an empty label (i.e. no label assigned to that n-gram). The highest-scoring label may be the label that was most frequently associated with the n-gram during training of the model. After determining the highest-scoring label for each individual n-gram, a single highest-scoring n-gram may be determined. The label for that highest-scoring n-gram may be applied to the token. In the example given above, the n-gram “goes well with blue” is the highest-scoring n-gram because 0.7 is the highest likelihood of any of the n-grams for the token “blue”. So in that example, the label “0” which indicates unlabelled would be applied to the token “blue”. Had the token alone been examined, without looking at the corresponding n-grams, the label “BLUE” would have been applied to the token “blue”, but because the corresponding n-grams were examined no label was applied to the token “blue”.

At step 2135 a confidence score associated with the assigned label's n-gram may be determined. The confidence score may be stored in the trained model. The confidence score may have been determined at step 2050 of the method 2000. The confidence score may indicate an amount of confidence that the label has been correctly assigned to the n-gram.

If none of the n-grams extracted at step 2120 were found in the model at step 2125, the method 2100 may proceed to step 2140. At step 2140 no label may be assigned to the token. An indication may be stored that the token was not assigned a label. The indication may be a special label that indicates that no label was assigned to the token. In some instances, rather than assigning a label indicating that no label was assigned, no label may be assigned to the token or some other indication that the token has not been labelled may be used.

After a label and confidence score has been assigned to the token at steps 2130 and 2135, or after an empty label has been assigned to the token at step 2140, a next {token, lemma} tuple may be selected to be labelled. At step 2145 a determination may be made as to whether there are any remaining {token, lemma} tuples to process. If all of the {token, lemma} tuples extracted at step 2110 have been labelled, the method 2100 may proceed to step 2150. Otherwise, another {token, lemma} tuple may be selected at step 2115 and labelled using the steps 2120 to 2140.

At step 2150 a confidence score may be generated for each product. The confidence score may be determined based on the labels assigned to the product. The confidence score may be determined based on an amount of root labels assigned to each product and/or an amount of child labels assigned to each product. The method 2200, described below and in FIGS. 22A and 22B, describes a method that may be used for determining a confidence score for a product.

At step 2155 an interface may be output. The interface may include all or a portion of the products that were labeled using the method 2100. For each displayed product, the confidence score associated with the product determined at step 2150 may be displayed. A human operator may then review, edit, and/or approve the labels for the products. The operator may approve a product after reviewing the labels, and the approved product may then be used to further train the auto-labelling model. In order to have the highest impact on improving the model, the operator may select to label products having lowest confidence scores.

FIGS. 22A and 22B illustrate a flow diagram of a method 2200 for determining product labelling confidence scores in accordance with various embodiments of the present technology. All or portions of the method 2200 may be executed by the product labeler 510. In one or more aspects, the method 2200 or one or more steps thereof may be performed by a computing system, such as the computing environment 100. The method 2200 or one or more steps thereof may be embodied in computer-executable instructions that are stored in a computer-readable medium, such as a non-transitory mass storage device, loaded into memory and executed by a CPU. The method 2200 is exemplary, and it should be understood that some steps or portions of steps in the flow diagram may be omitted and/or changed in order.

At step 2205 a product database of labelled products may be received. The database may include a set of products, text corresponding to each of the products, images of the products, labels assigned to the text corresponding to each of the products, a confidence score for each of the labels, an ontology including all of the labels assigned to the products and/or any other information regarding the products. Although described as a database, it should be understood that product information may be received in any suitable format.

At step 2210 a joint distribution may be generated for each root label in the ontology. The ontology of the labels assigned to the products may be in a hierarchical format. The ontology may include root labels and/or child labels of the root labels. The root label may be a category, and the child label may be an attribute in that category. For example a root label may be “apparel” and child labels of that root label may be “jacket” “shirt” “pants”, etc.

The joint distribution may provide a statistical estimate of how many child labels per root label can be considered normal if they were assigned for a product. For instance, it is most likely for a product to be compatible with a single skin type for a product (e.g. oily skin, dry skin, etc.). In another example if a product addresses skin concerns (e.g. wrinkles, crow's feet, radiance, etc.) it would be more likely for the product to address two or three skin concerns at the same time rather than being labelled with a single skin concern.

At step 2215 a product in the database may be selected. The products may be selected in any order.

At step 2220 a root label from the ontology may be selected. The root labels may be selected in any order.

At step 2225 the number of child labels of the selected root label that were assigned to the product may be counted. For example if the root label is “printer” and the child labels of “printer” that are assigned to the product are “laser” “monochrome” and “integrated display”, then the count for that root label would be three.

At step 2230 a distance between the number of child labels and the joint distribution for the root label may be determined. The distance may be stored as a root label confidence score. This distance may provide an estimate of how likely the number of labels for that root label of the given product is to be normal. The smaller the distance, the higher the confidence for that root label to be normally labeled is. For example if the root label “season” is typically assigned one or two child labels, and the product has been assigned two child labels of that root label, then the distance may be relatively small. But if, in this same example, the product was assigned four child labels of the root label, the distance may be relatively large.

At step 2235 a determination may be made as to whether there are any remaining root labels in the ontology to process. If all root labels have already been selected at step 2220 and assigned a confidence score, then the method 2200 may proceed to step 2240. Otherwise, if there are any remaining root labels to select, the method 2200 may return to step 2220 where one of the root labels in the ontology that has not yet been selected may be selected.

At step 2240 a weighted average of root label confidence scores for the product may be determined. The weighted average may be based on each of the root label confidence scores determined for the product. A root label confidence score may have been determined, at step 2230, for each root label in the ontology. The weighted average may represent a single confidence score indicating the likelihood that the number of labels assigned to the product is the correct number of labels. The weighted average may be determined using a formula with manually assigned weights. In some instances, rather than performing a weighted average, a minimum or maximum root label confidence score may be selected at step 2240.

At step 2245 a weighted average of the confidence scores of all labels assigned to the product may be determined. A confidence score may have been determined for each individual label that was assigned to the product. The confidence scores may have been determined at step 2135 of the method 2100. A weighted average of all of the labelling confidence scores may be determined for the product. The weighted average may be determined using a formula with manually assigned weights. In some instances, rather than performing a weighted average, a minimum or maximum of the label confidence scores may be selected at step 2245 as the confidence score for all labels.

At step 2250 an overall confidence score for the product may be determined. The overall confidence score may be determined based on the weighted averages determined at steps 2240 and 2245. The overall confidence score may be a weighted average of the root label confidence score weighted average (step 2240) and the all label confidence score weighted average (2245). The overall confidence score may indicate a predicted likelihood that the auto-labelling model correctly labelled the product. The overall confidence score may be determined using a formula with manually assigned weights. In some instances, rather than performing a weighted average, a minimum or maximum of the weighted averages determined at steps 2240 and 2245 may be selected at step 2250 as the overall confidence score.

At step 2255 a determination may be made as to whether there are any additional products in the database that have not yet been selected at step 2215. If a confidence score has already been generated for each of the products in the database, the method 2200 may continue to step 2260. Otherwise, if there are any products remaining in the database to determine a confidence score for, the method 2200 may continue at step 2215 where a product that has not yet been selected may be selected.

At step 2260 the products in the database may be ranked. The products may be ranked based on the overall confidence score for each product. Any other attribute of the products may be used for ranking the products, such as an amount of labels assigned to each product, the date when each product was added to the database, etc.

At step 2265 an interface may be output. The interface may include all or a portion of the products in the product database. For each displayed product, the overall confidence score associated with the product determined at step 2250 may be displayed. A human operator may then review, edit, and/or approve the labels for the products. The operator may approve a product after reviewing the labels, and the approved product may then be used to further train the auto-labelling model. In order to have the highest impact on improving the model, the operator may select to label products having lowest confidence scores. The products may be displayed in a ranking based on their confidence scores so that the human operator can identify which order of manual curation would have the highest impact for teaching new learnings to the auto-labelling algorithm. The products having the lowest confidence score may be ranked highest, as these would likely have the most impact on training the auto-labelling model if reviewed by the human operator.

### Interfaces

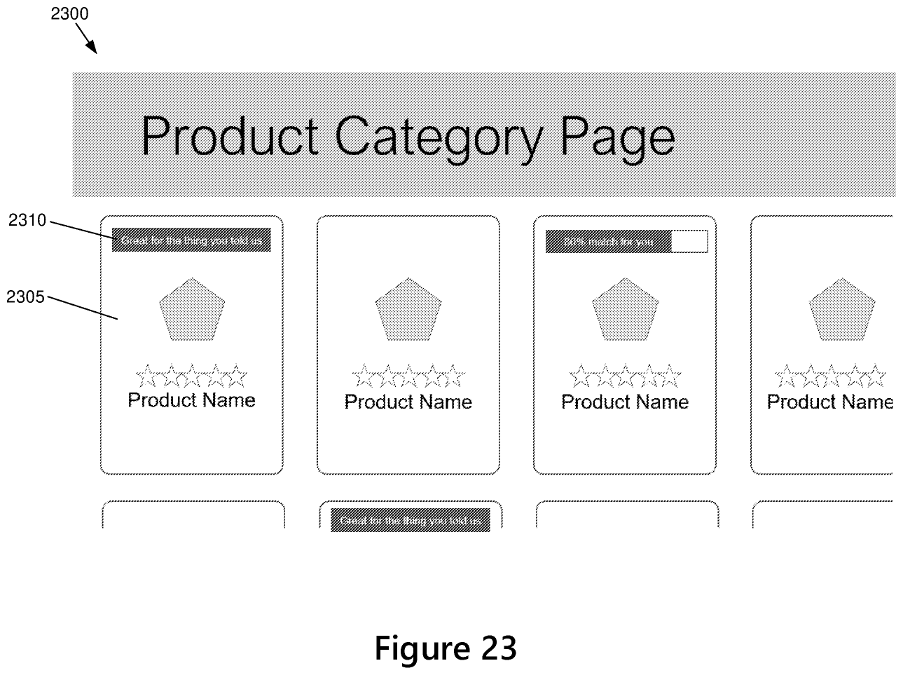

FIG. 23 illustrates a product personalization interface 2300 in accordance with various embodiments of the present technology. The product personalization interface 2300 is an example of a web page that may be generated using the method 700, described above and in FIG. 7. When a user visits a web page or other interface of a retailer, interface elements corresponding to products may be displayed, such as the product element 2305. The product element 2305 may include a name of the product, photograph or illustration of the product, rating of the product, reviews of the product, and/or other information corresponding to the product.

As described in the method 700, products recommendations may be determined for the user accessing the product personalization interface 2300. The recommendations may be determined based on comparing the user's profile to the available products. A label 2310 may be applied to the product element 2305 to indicate that the product corresponding to the product element 2305 is a recommended product. The label 2310 may include text indicating why the product was recommended. For example the label 2310 may include text indicating that the recommended product corresponds to one or more of the labels in the user's profile.

FIG. 24 illustrates a web page 2400 with a banner in accordance with various embodiments of the present technology. The web page 2400 may be a retailer's web page, or a web page corresponding to any other entity. Although described as a web page 2400, the interface illustrated in FIG. 24 may be displayed by an application other than a web browser, such as a retailer's mobile application.

The web page 2400 may comprise a banner 2410. The banner 2410 may include a logo of the retailer, images of one or more products, an advertisement, and/or any other information. The banner 2410 may include a prompt 2415 suggesting that a user accessing the web page 2400 begin a dialog. A selectable element 2420 may be selected by the user to begin the dialog. Upon selecting the selectable element 2420, a dialog interface may be overlaid on a portion of the banner 2410.

FIG. 25 illustrates a banner chat interface 2500 in accordance with various embodiments of the present technology. In the banner chat interface 2500, a dialog interface 2510 has been overlaid on the banner 2410. After the selectable element 2420 is selected in the web page 2400, the banner 2410 may transition with the dialog interface 2510 scrolling over from the right side of the banner 2410 and covering a portion of the banner 2410. The dialog interface 2510 may include one or more selectable elements 2520 and 2530. The selectable elements 2520 and 2530 may include pre-filled responses that a user can select. The selectable elements 2520 and 2530 may be defined in the bot template model corresponding to the dialog. A text input area 2540 may permit the user to enter a text response to the dialog. The user may choose whether they wish to interact with the dialog by selecting one of the selectable elements 2520 and 2530 or entering a response in the text input area 2540.

While some of the above-described implementations may have been described and shown with reference to particular acts performed in a particular order, it will be understood that these acts may be combined, sub-divided, or re-ordered without departing from the teachings of the present technology. At least some of the acts may be executed in parallel or in series. Accordingly, the order and grouping of the act is not a limitation of the present technology.

It should be expressly understood that not all technical effects mentioned herein need be enjoyed in each and every embodiment of the present technology.

As used herein, the wording “and/or” is intended to represent an inclusive-or; for example, “X and/or Y” is intended to mean X or Y or both. As a further example, “X, Y, and/or Z” is intended to mean X or Y or Z or any combination thereof.

The foregoing description is intended to be exemplary rather than limiting. Modifications and improvements to the above-described implementations of the present technology may be apparent to those skilled in the art.

1-67. (canceled)

68. A method for determining product recommendations for a user, the method comprising:
receiving a request for product recommendations corresponding to the user;
retrieving a user profile of the user;
selecting, from a database of products and based on the user profile, a plurality of products that are recommendable to the user; and
outputting the plurality of products.

69. The method of claim 68, further comprising:
causing output of a web page, wherein the web page comprises images of the plurality of products; and
displaying, on the web page, indicators overlaid on the images of the plurality of products, wherein the indicators indicate that each product of the plurality of products is a recommended product.

70. The method of claim 68, further comprising causing display, on a web page, of indications that each product of the plurality of products is a recommended product.

71. The method of claim 68, wherein the request comprises an amount of products to recommend, and wherein selecting the plurality of products comprises selecting the amount of products to recommend.

72. The method of claim 68, further comprising generating, for each respective product of the plurality of products, text indicating why the respective product is being recommended, wherein the text indicates how labels associated with the respective product correspond to labels in the user profile.

73. The method of claim 68, wherein selecting the plurality of products comprises comparing labels assigned to products in the database of products to labels in the user profile.

74. The method of claim 73, further comprising:
determining, for each product of the plurality of products, a distance between the labels assigned to the respective product and labels in the user profile; and
ranking, based on the distance for each product of the plurality of products, the plurality of products.

75. The method of claim 74, further comprising displaying a user interface comprising a highest-ranked product of the plurality of products.

76. The method of claim 68 further comprising:
determining that a product in the database of products is unavailable; and
storing, in the database of products, an indication that the product is not available to be recommended.

77. A system comprising at least one processor and memory comprising executable instructions which, when executed by the at least one processor, cause the system to:
receive a request for product recommendations corresponding to a user;
retrieve a user profile of the user;
retrieve bundle specifications;
determine, based on the user profile and the bundle specifications, a bundle type that is recommendable to the user;
select, based on comparing labels in the user profile to product labels, a plurality of products from a database of products, wherein the products correspond to the bundle type; and
output the plurality of products.

78. The system of claim 77, wherein the bundle specifications comprise a set of rules indicating which products can be bundled together and which types of products can be bundled together.

79. The system of claim 77, wherein the instructions cause the system to display a web page, wherein the web page comprises images of the plurality of products.

80. The system of claim 79, wherein the instructions cause the system to display, on the web page, indicators, overlaid on the images of the plurality of products, indicating that each product of the plurality of products is a recommended product.

81. The system of claim 77, wherein the instructions that cause the system to select the plurality of products comprise instructions that cause the system to determine, for each product of the plurality of products, a distance between labels assigned to the respective product and labels in the user profile.

82. A method for outputting product recommendations, the method comprising:
receiving a request for product recommendations corresponding to a user;
retrieving a user profile of the user;
selecting, from a database of products and based on the user profile, a plurality of products that are recommendable to the user;
ranking, based on the user profile, the plurality of products;
displaying a web page comprising a highest-ranked product of the plurality of products; and
displaying, on the web page, an indicator that the highest-ranked product is a recommended product for the user.

83. The method of claim 82, further comprising displaying, on the web page, text indicating why the highest-ranked product is being recommended for the user.

84. The method of claim 83, wherein the text indicates how labels associated with the highest-ranked product correspond to labels in the user profile.

85. The method of claim 82, wherein selecting the plurality of products comprises comparing labels assigned to products in the database of products to labels in the user profile.

86. The method of claim 85, further comprising:
determining, for each product of the plurality of products, a distance between the labels assigned to the respective product and labels in the user profile; and
wherein ranking the plurality of products comprises ranking, based on the distance for each product of the plurality of products, the plurality of products.

87. The method of claim 86, wherein the highest-ranked product has a least distance of the plurality of products.
